(19) United States
(12) Patent Application Publication
(10) Pub. No.: US 2008/0045441 A1
(43) Pub. Date: Feb. 21, 2008

(54) Cleaning Agent Components

(75) Inventors: Peter Schmiedel, Dusseldorf (DE); Ulrich Pegelow, Dusseldorf (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/663,234

(22) PCT Filed: Sep. 8, 2005
(86) PCT No.: PCT/EP05/09649

§ 371 Date: Apr. 23, 2007

(30) Foreign Application Priority Data
Sep. 17, 2004 (DE) 102004045685.2

(51) Int. Cl. C11D 3/20

(52) U.S. Cl. 510/514

(57) ABSTRACT

Liquid, cleaning-agent compositions suitable for use in automatic dishwashers and methods of using the same are described, wherein the compositions comprise: (a) 35 to 95 wt % of one or more hydroxy mixed ethers according to the general formula:
R¹—O—[CH₂CH(R³)O]ₓ—[CH₂CH(OH)]—R²
wherein x represents a number greater than 1; R¹ represents a linear or branched, saturated or unsaturated, aliphatic or aromatic hydrocarbon radical having 1 to 30 carbon atoms; R² represents a linear or branched, saturated or unsaturated, aliphatic or aromatic hydrocarbon radical having 1 to 30 carbon atoms and, optionally, substituents selected from the group consisting of up to 5 hydroxy functionalities, up to 3 ether functionalities, and combinations thereof; and each R³ independently represents a substituent selected from the group consisting of hydrogen, methyl, ethyl, n-propyl, isopropyl, n-butyl, 2-butyl, and 2-methylbutyl; and
(b) 5 to 65 wt % of one or more glycerides selected from the group consisting of monoesters, diesters and triesters of glycerol with one or more C₁₋₁₀ monocarboxylic acids, and mixtures thereof.

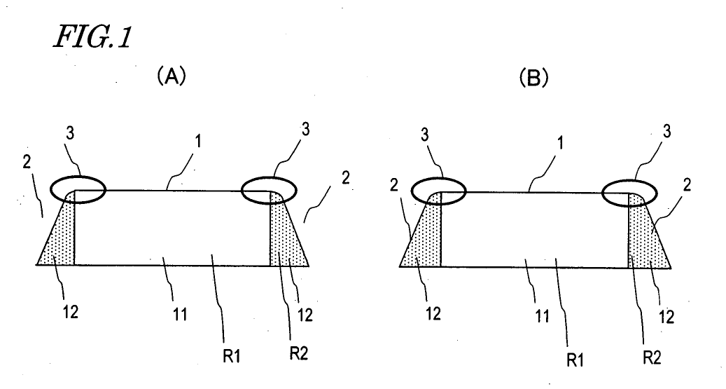

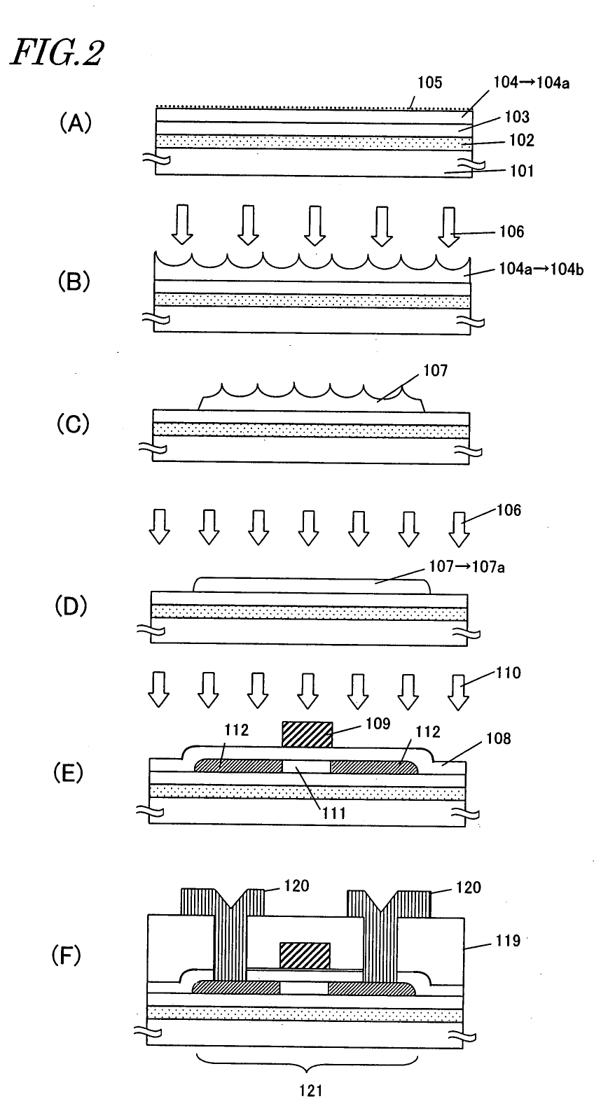

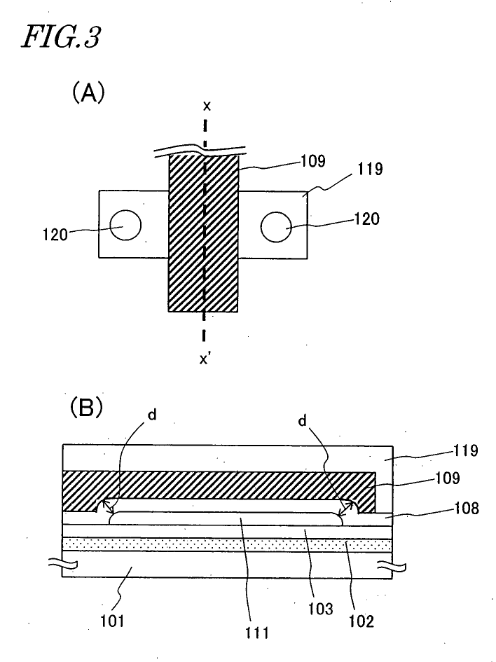

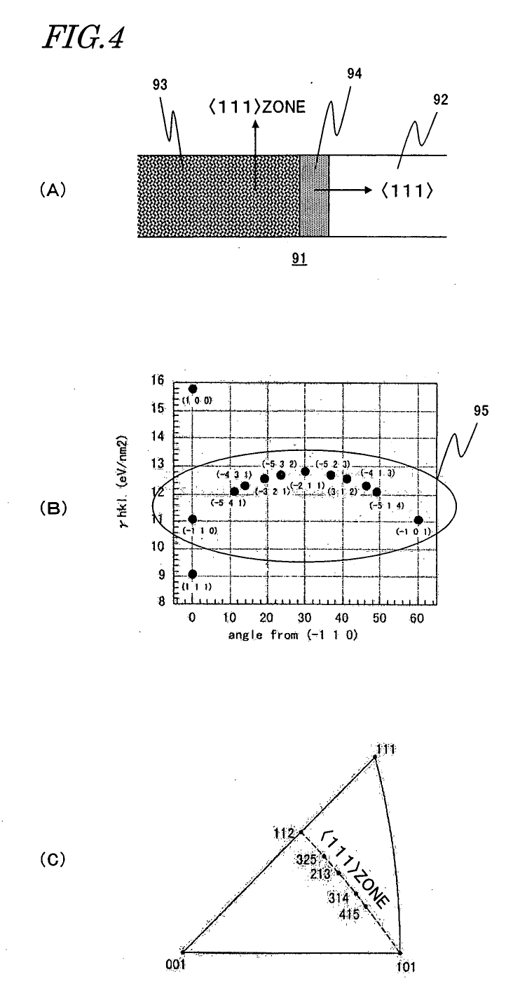

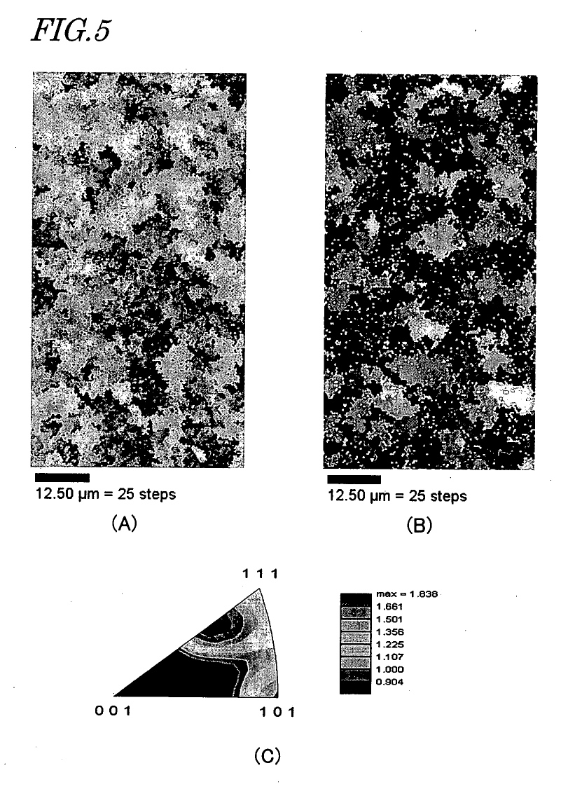

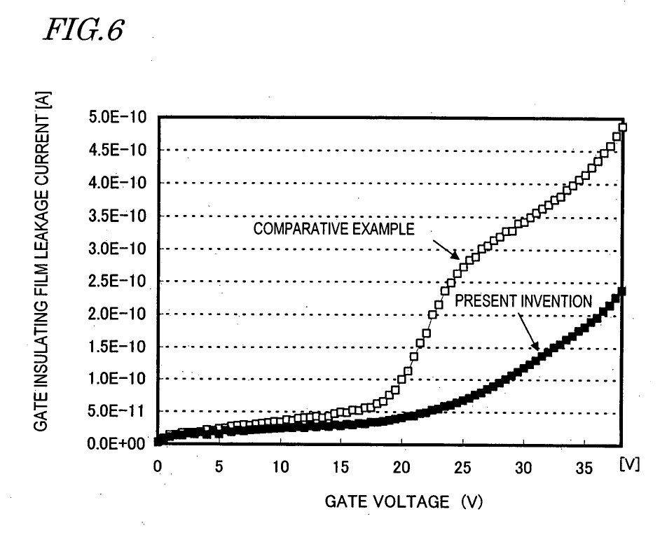

The present invention relates to liquid cleaning-agent compositions that contain at least one compound from the group of the hydroxy mixed ethers, one or more esters of glycerol with monocarboxylic acids, and optionally further cleaning-agent constituents, and to the use of said liquid cleaning-agent compositions to improve the clear-rinsing result of automatic dishwashing operations.

Agents for automatic washing of tableware in ordinary household automatic dishwashers are available on the market in a very wide variety of embodiments. In addition to the previously common powdered cleaning agents, shaped elements, i.e. cleaning-agent tablets, have become established. Particular difficulties are encountered in the formulation of liquid agents, inter alia because ingredients of the liquid agents may exhibit an incompatibility with the polymer-containing casing materials that are required. The simplest example is the limitation that aqueous liquid agents cannot be presented in packages containing poly(vinyl alcohol) (e.g. PVA film), since the water contained therein dissolves the poly(vinyl alcohol)-containing casing materials more or less rapidly depending on the water solubility of the packaging film and the free water content of the agent. When water is used as a liquid base, stability problems furthermore exist for a number of ingredients. One approach to a solution here is to formulate non-aqueous, i.e. substantially anhydrous, cleaning agents. An extensive related art also exists, for example, regarding both non-aqueous (usually solvent-based) and also aqueous dishwashing agents for washing tableware in an ordinary household automatic dishwasher.

DE 20 29 598, for example, describes liquid cleaning-agent compositions that contain 14 to 35 wt % sodium tripolyphosphate, 0.1 to 50 wt % of a potassium and/or ammonium salt of an inorganic or organic acid, water, and optionally surfactants, solubilizers, sequestering agents, peracids, and other ingredients.

Linear viscoelastic cleaning-agent compositions for automatic dishwashing are also described in European Patent Application EP 446 761 (Colgate). The compositions disclosed therein contain up to 2 wt % of a long-chain fatty acid or a salt thereof, 0.1 to 5 wt % surfactant, 5 to 40 wt % water-soluble builders, and up to 20 wt % chlorine bleaching agent and a polycarboxylate thickener; the ratio of potassium to sodium ions in the compositions is intended to be 1:1 to 45:1.

Automatic dishwashing agents in the form of clear, transparent gels are disclosed in European Patent Application EP 439 878 (Union Camp Corp.). The compositions disclosed therein contain a polyacrylate thickening agent that forms a gel matrix with water, surfactant, bleaching agent, a builder, and water.

Gelled automatic dishwashing agents are also described in European Patent Application EP 611 206 (Colgate). These compositions contain 1 to 12 wt % of a liquid nonionic surfactant, 2 to 70 wt % builder, as well as enzymes and a stabilization system that is made up of swelling substances and hydroxypropyl cellulose.

Viscoelastic, thixotropic dishwashing agents, having 0.001 to 5 wt % surfactant as well as enzymes and an enzyme stabilization system made up of boric acid and polyhydroxy compounds, are described in International Patent Application WO 93/21299 (Procter & Gamble). The agents disclosed here likewise contain 0.1 to 10 wt % of one or more thickening agents.

The aforesaid documents all disclose liquid to gelled dishwashing compositions having a low surfactant concentration. It is specifically a high proportion of surfactants, however, especially a high content of nonionic surfactants, that guarantees a good clear-rinsing result.

Attempts to manufacture liquid agents having a much higher surfactant concentration have hitherto failed, for example, because the nonionic surfactants used have melting points above room temperature. Agents that contain such nonionic surfactants in high concentrations are waxy, and are not accepted by the consumer because of their less attractive appearance. In addition, with agents of this kind an elevation of the surfactant content also often does not lead to the expected performance increase.

It was the object of the present invention to make available a highly active agent that has a high concentration of surfactants, especially nonionic surfactants, and is liquid at room temperature. The agent was intended to provide an improved clear-rinsing result, as compared with agents of the existing art, in terms of automatic tableware washing. The agent was also intended to be presented in an attractive product design.

It has now been found, surprisingly, that cleaning-agent compositions that are liquid at room temperature and have a high surfactant content can be made available when nonionic surfactants from the group of the hydroxy mixed ethers are formulated with stabilizers from the group of the esters of glycerol and C₁₋₁₀ monocarboxylic acids.

The subject matter of the present invention is liquid cleaning-agent compositions containing
a) 35 to 95 wt % hydroxy mixed ethers of the formula
   R¹—O—[CH₂CH(R³)O]ₓ—[CH₂CH(OH)]—R²
   in which R¹ and R² can be different or identical,
   R¹ denoting a linear or branched, saturated or unsaturated, aliphatic or aromatic hydrocarbon radical having 1 to 30 carbon atoms, or mixtures thereof, R² denoting a linear or branched, saturated or unsaturated, aliphatic or aromatic hydrocarbon radical having 1 to 30 carbon atoms, which optionally contains up to 5 hydroxy and/or up to 3 ether functions, R³ denoting H or a methyl, ethyl, n-propyl, isopropyl, n-butyl, 2-butyl, or 2-methylbutyl radical, such that when x≧2, each R³ can be different, and x denoting values greater than 1; and
b) 5 to 65 wt % of one or more mono- and/or di- and/or triesters of glycerol with C₁₋₁₀ monocarboxylic acids.

Cleaning-agent compositions according to the present invention that contain 35 to 95 wt % hydroxy mixed ethers of the aforesaid formula (a)) and 5 to 65 wt % of the aforesaid stabilizers (b)) have a melting point that is well below room temperature, and are therefore present in a liquid consistency that varies depending on the country, season, and consumer habits. The melting point or melting range of the composition is by preference below 20° C., preferably below 17.5° C., particularly preferably below 15° C., very particularly preferably below 12.5° C., and in particular below 10° C.

In the context of this invention, the term “liquid” also encompasses those states of the compositions that are commonly referred to as viscous or gelled.

Nonionic surfactants from the group of the hydroxy mixed ethers are contained as an essential constituent in the cleaning-agent compositions according to the present invention. The washing or cleaning agent according to the present invention contains hydroxy mixed ethers by preference in a proportion from 30 to 90 wt %, preferably 35 to 80 wt %, particularly preferably from 40 to 70 wt %, and in particular 50 to 70 wt %, based on the entire agent.

Hydroxy mixed ethers of the formula
R¹O[CH₂CH(CH₃)O]ₓ[CH₂CH₂O]_{y}CH₂CH(OH)R²
in which R¹ denotes a linear or branched aliphatic hydrocarbon radical having 4 to 18 carbon atoms or mixtures thereof, R² designates a linear or branched hydrocarbon radical having 2 to 26 carbon atoms or mixtures thereof, and x denotes values between 0.5 and 1.5 and y a value of at least 15, are particularly preferred.

Additional hydroxy mixed ethers that are usable in preferred fashion are the end-capped poly(oxyalkylated) nonionic surfactants of the following formula:
R¹O[CH₂CH(R³)O]ₓCH₂CH(OH)[CH₂]ⱼOR²,
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and j denotes values between 1 and 12, preferably between 1 and 5. If the value of x=2, each R³ in the formula above can be different. R¹ and R² are preferably linear or branched, saturated or unsaturated, aliphatic or aromatic hydrocarbon radicals having 6 to 22 carbon atoms, radicals having 8 to 18 C atoms being particularly preferred. For the R³ radical, H, —CH₃, or —CH₂CH₃ are particularly preferred. Particularly preferred values for x are in the range from 1 to 20, in particular from 6 to 15.

As described above, each R³ in the formula above can be different if x=2. The alkylene oxide unit in the square brackets can thereby be varied. If, for example, x denotes 3, the R³ radical can be selected so as to form ethylene oxide units (R³═H) or propylene oxide (R³═CH₃) units that can be joined onto one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected as an example here, and can certainly be larger; the range of variation increases with rising values of x, and includes e.g. a large number of (EO) groups combined with a small number of (PO) groups, or vice versa.

Particularly preferred hydroxy mixed ethers of the above formula have values of j=1, so that the formula above is simplified to
R¹O[CH₂CH(R³)O]ₓCH₂CH(OH)CH₂OR².
In the latter formula, R¹, R², and R³ are as defined above, and x denotes numbers from 1 to 30, preferably from 1 to 20, and in particular from 6 to 18. Hydroxy mixed ethers in which the R¹ and R² radicals have 9 to 14 C atoms, R³ denotes H, and x assumes values from 6 to 15, are particularly preferred.

Summarizing what has just been stated, end-capped hydroxy mixed ethers of the formula
R¹O[CH₂CH(R³)O]ₓCH₂CH(OH)[CH₂]ⱼOR²,
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30, and j denotes values between 1 and 12, preferably between 1 and 5, are preferred, hydroxy mixed ethers of the
R¹O[CH₂CH(R³)O]ₓCH₂CH(OH)CH₂OR²
type, in which x denotes numbers from 1 to 30, preferably from 1 to 20, and in particular from 6 to 18, being particularly preferred.

Particularly preferred are hydroxy mixed ethers of the general formula
R¹O[CH₂CH₂O]ₓCH₂CH(OH)R²
that, in addition to an R¹ radical that denotes linear or branched, saturated or unsaturated, aliphatic or aromatic hydrocarbon radicals having 1 to 30 carbon atoms, preferably having 4 to 22 carbon atoms, additionally comprise a linear or branched, saturated or unsaturated, aliphatic or aromatic hydrocarbon radical R² having 1 to 30 carbon atoms, by preference 2 to 22 carbon atoms, which is adjacent to a monohydroxylated intermediate group —CH₂CH(OH)— and in which x denotes values between 40 and 80, by preference values between 40 and 60.

Additionally particularly preferred are those end-capped hydroxy mixed ethers of the formula
R¹O[CH₂CH₂O]ₓ[CH₂CH(CH₃)O]_{y}CH₂CH(OH)R²
in which R¹ and R², mutually independently, denote a linear or branched, saturated or mono- or polyunsaturated hydrocarbon radical having 2 to 26 carbon atoms, R³ is selected, mutually independently, from —CH₃—CH₂CH₃, —CH₂CH₂—CH₃, CH(CH₃)₂, but preferably denotes —CH₃, and x and y, mutually independently, denote values between 1 and 32, hydroxy mixed ethers having values for x from 15 to 32 and for y from 0.5 to 1.5 being very particularly preferred.

Hydroxy mixed ethers of the general formula
R¹O[CH₂CH₂O]ₓ[CH₂CH(R³)O]_{y}CH₂CH(OH)R²
in which R¹ and R², mutually independently, denote a linear or branched, saturated or mono- or polyunsaturated hydrocarbon radical having 2 to 26 carbon atoms, R³ is selected, mutually independently, from —CH₃—CH₂CH₃, —CH₂CH₂—CH₃, CH(CH₃)₂, but preferably denotes —CH₃, and x and y, mutually independently, denote values between 1 and 32, are preferred according to the present invention, hydroxy mixed ethers having values for x from 15 to 32 and for y from 0.5 to 1.5 being very particularly preferred.

The carbon chain lengths and degrees of ethoxylation or alkoxylation indicated for the aforesaid hydroxy mixed ethers represent statistical averages that may be an integer or a fractional number for a specific product. As a result of production methods, commercial products of the aforesaid formulas are usually made up not of an individual representative but rather of mixtures, so that average values and, as a consequence, fractional numbers, can result both for the carbon chain lengths and for the degrees of ethoxylation and alkoxylation.

The aforesaid hydroxy mixed ethers can of course be used not only as individual substances, but also as mixtures of two, three, four, or more hydroxy mixed ethers. “Mixtures” refers not to mixes of hydroxy mixed ethers that fall, in their totality, under one of the aforesaid general formulas, but instead to those mixtures containing two, three, four, or more hydroxy mixed ethers that can be described by different ones of the aforesaid general formulas.

Hydroxy mixed ethers that have a melting point below 60° C. are particularly preferred. Hydroxy mixed ethers having a melting point below 50° C., by preference below 45° C., and in particular between 26.6 and 43.3° C. are particularly preferred.

A preferred subject of the present invention is a liquid cleaning-agent composition containing a) 35 to 95 wt % hydroxy mixed ethers of the formula
R¹—O—[CH₂CH(R³)O]ₓ—[CH₂CH(OH)]—R²
in which R¹ and R² can be different or identical,
R¹ denoting a linear or branched, saturated or unsaturated, aliphatic or aromatic hydrocarbon radical having 1 to 30 carbon atoms, or mixtures thereof, R² denoting a linear or branched, saturated or unsaturated, aliphatic or aromatic hydrocarbon radical having 1 to 30 carbon atoms, which optionally contains up to 5 hydroxy and/or up to 3 ether functions, R³ denoting H or a methyl, ethyl, n-propyl, isopropyl, n-butyl, 2-butyl, or 2-methylbutyl radical, such that when x≧2, each R³ can be different, and x denoting values greater than 1; and
b) 5 to 65 wt % of one or more mono- and/or di- and/or triesters of glycerol with C₁₋₁₀ monocarboxylic acids,
   at least one, preferably each, of the hydroxy mixed ethers having a melting point below 45° C.

If the automatic dishwashing agent according to the present invention contains two, three, four, or more hydroxy mixed ethers, the quantitative ratio of the hydroxy mixed ethers contained in the agent preferably lies within narrow boundaries. If a mixture of two hydroxy mixed ethers is used, the weight ratio to one another of the hydroxy mixed ethers used is by preference between 10:1 and 1:10, preferably between 8:1 and 1:8, particularly preferably between 6:1 and 1:6, and in particular between 4:1 and 1:4.

If the automatic dishwashing agent according to the present invention contains a mixture of two, three, four, or more hydroxy mixed ethers, it is then preferred if at least one of the hydroxy mixed ethers constitutes a weight proportion above 1.0 wt %, preferably above 2 wt %, and in particular above 5 wt %, based on the entire agent.

The second essential constituent of the cleaning-agent compositions according to the present invention is stabilizers from the group of the mono- and/or di- and/or triesters of glycerol with C₁₋₁₀ monocarboxylic acids. The concentration of these esters, based on the composition, is by preference 10 to 60 wt %, preferably 20 to 50 wt %, and in particular 30 to 45 wt %.

Particularly preferred here are the n-carboxylic acids methanoic acid, ethanoic acid, propanoic acid, butanoic acid, pentanoic acid, hexanoic acid, heptanoic acid, octanoic acid, nonanoic acid, and decanoic acid, so that cleaning-agent compositions preferred according to the present invention contain one or more substances from the group CH₂(OH)—CH(OH)—CH₂(O—C(O)—CH₃), CH₂(OH)—CH(O—C(O)—CH₃)—CH₂(OH), CH₂(OH)—CH(O—C(O)—CH₃)—CH₂(O—C(O)—CH₃), CH₂(O—C(O)—CH₃)—CH(OH)—CH₂(O—C(O)—CH₃), CH₂(O—C(O)—CH₃)—CH(O—C(O)—CH₃)—CH₂(O—C(O)—CH₃), CH₂(OH)—CH(OH)—CH₂(O—C(O)—CH₂CH₃), CH₂(OH)—CH(O—C(O)—CH₂CH₃)—CH₂(OH), CH₂(OH)—CH(O—C(O)—CH₂CH₃)—CH₂(O—C(O)—CH₂CH₃), CH₂(O—C(O)—CH₂CH₃)—CH(OH)—CH₂(O—C(O)—CH₂CH₃), CH₂(O—C(O)—CH₂CH₃)—CH(O—C(O)—CH₂CH₃)—CH₂(O—C(O)—CH₂CH₃), CH₂(OH)—CH(OH)—CH₂(O—C(O)—CH₂CH₂CH₃), CH₂(OH)—CH(O—C(O)—CH₂CH₂CH₃)—CH₂(OH), CH₂(OH)—CH(O—C(O)—CH₂CH₂CH₃)—CH₂(O—C(O)—CH₂CH₂CH₃), CH₂(O—C(O)—CH₂CH₂CH₃)—CH(OH)—CH₂(O—C(O)—CH₂CH₂CH₃), CH₂(O—C(O)—CH₂CH₂CH₃)—CH(O—C(O)—CH₂CH₂CH₃)—CH₂(O—C(O)—CH₂CH₂CH₃), CH₂(OH)—CH(OH)—CH₂(O—C(O)—CH₂CH₂CH₂CH₃), CH₂(OH)—CH(O—C(O)—CH₂CH₂CH₂CH₃)—CH₂(OH), CH₂(OH)—CH(O—C(O)—CH₂CH₂CH₂CH₃)—CH₂(O—C(O)—CH₂CH₂CH₂CH₃), CH₂(O—C(O)—CH₂CH₂CH₂CH₃)—CH(OH)—CH₂(O—C(O)—CH₂CH₂CH₂CH₃), CH₂(O—C(O)—CH₂CH₂CH₂CH₃)—CH(O—C(O)—CH₂CH₂CH₂CH₃)—CH₂(O—C(O)—CH₂CH₂CH₂CH₃), CH₂(OH)—CH(OH)—CH₂(O—C(O)—CH₂CH₂CH₂CH₂CH₃), CH₂(OH)—CH(O—C(O)—CH₂CH₂CH₂CH₂CH₃)—CH₂(OH), CH₂(OH)—CH(O—C(O)—CH₂CH₂CH₂CH₂CH₃)—CH₂(O—C(O)—CH₂CH₂CH₂CH₂CH₃), CH₂(O—C(O)—CH₂CH₂CH₂CH₂CH₃)—CH(OH)—CH₂(O—C(O)—CH₂CH₂CH₂CH₂CH₃), CH₂(O—C(O)—CH₂CH₂CH₂CH₂CH₃)—CH(O—C(O)—CH₂CH₂CH₂CH₂CH₃)—CH₂(O—C(O)—CH₂CH₂CH₂CH₂CH₃), CH₂(OH)—CH(OH)—CH₂(O—C(O)—CH₂CH₂CH₂CH₂CH₂CH₃), CH₂(OH)—CH(O—C(O)—CH₂CH₂CH₂CH₂CH₂CH₃)—CH₂(OH), CH₂(OH)—CH(O—C(O)—CH₂CH₂CH₂CH₂CH₂CH₃)—CH₂(O—C(O)—CH₂CH₂CH₂CH₂CH₂CH₃), CH₂(O—C(O)—CH₂CH₂CH₂CH₂CH₂CH₃)—CH(OH)—CH₂(O—C(O)—CH₂CH₂CH₂CH₂CH₂CH₃), CH₂(O—C(O)—CH₂CH₂CH₂CH₂CH₂CH₃)—CH(O—C(O)—CH₂CH₂CH₂CH₂CH₂CH₃)—CH₂(O—C(O)—CH₂CH₂CH₂CH₂CH₂CH₃), CH₂(OH)—CH(OH)—CH₂(O—C(O)—CH₂CH₂CH₂CH₂CH₂CH₂CH₃), CH₂(OH)—CH(O—C(O)—CH₂CH₂CH₂CH₂CH₂CH₂CH₃)—CH₂(OH), CH₂(OH)—CH(O—C(O)—CH₂CH₂CH₂CH₂CH₂CH₂CH₃)—CH₂(O—C(O)—CH₂CH₂CH₂CH₂CH₂CH₂CH₃), CH₂(O—C(O)—CH₂CH₂CH₂CH₂CH₂CH₂CH₃)—CH(OH)—CH₂(O—C(O)—CH₂CH₂CH₂CH₂CH₂CH₂CH₃), CH₂(O—C(O)—CH₂CH₂CH₂CH₂CH₂CH₂CH₃)—CH(O—C(O)—CH₂CH₂CH₂CH₂CH₂CH₂CH₃)—CH₂(O—C(O)—CH₂CH₂CH₂CH₂CH₂CH₂CH₃), CH₂(OH)—CH(OH)—CH₂(O—C(O)—CH₂CH₂CH₂CH₂CH₂CH₂CH₂CH₃), CH₂(OH)—CH(O—C(O)—CH₂CH₂CH₂CH₂CH₂CH₂CH₂CH₃)—CH₂(OH), CH₂(OH)—CH(O—C(O)—CH₂CH₂CH₂CH₂CH₂CH₂CH₂CH₃)—CH₂(O—C(O)—CH₂CH₂CH₂CH₂CH₂CH₂CH₂CH₃), CH₂(O—C(O)—CH₂CH₂CH₂CH₂CH₂CH₂CH₂CH₃)—CH(OH)—CH₂(O—C(O)—CH₂CH₂CH₂CH₂CH₂CH₂CH₂CH₃), CH₂(O—C(O)—CH₂CH₂CH₂CH₂CH₂CH₂CH₂CH₃)—CH(O—C(O)—CH₂CH₂CH₂CH₂CH₂CH₂CH₂CH₃)—CH₂(O—C(O)—CH₂CH₂CH₂CH₂CH₂CH₂CH₂CH₃), CH₂(OH)—CH(OH)—CH₂(O—C(O)—CH₂CH₂CH₂CH₂CH₂CH₂CH₂CH₂CH₃), CH₂(OH)—CH(O—C(O)—CH₂CH₂CH₂CH₂CH₂CH₂CH₂CH₂CH₃)—CH₂(OH), CH₂(OH)—CH(O—C(O)—CH₂CH₂CH₂CH₂CH₂CH₂CH₂CH₂CH₃)—CH₂(O—C(O)—CH₂CH₂CH₂CH₂CH₂CH₂CH₂CH₂CH₃), CH₂(O—C(O)—CH₂CH₂CH₂CH₂CH₂CH₂CH₂CH₂CH₃)—CH(OH)—CH₂(O—C(O)—CH₂CH₂CH₂CH₂CH₂CH₂CH₂CH₂CH₃), CH₂(O—C(O)—CH₂CH₂CH₂CH₂CH₂CH₂CH₂CH₂CH₃)—CH(O—C(O)—CH₂CH₂CH₂CH₂CH₂CH₂CH₂CH₂CH₃)—CH₂(O—C(O)—CH₂CH₂CH₂CH₂CH₂CH₂CH₂CH₂CH₃), CH₂(OH)—CH(OH)—CH₂(O—C(O)—CH₂CH₂CH₂CH₂CH₂CH₂CH₂CH₂CH₂CH₃), CH₂(OH)—CH(O—C(O)—CH₂CH₂CH₂CH₂CH₂CH₂CH₂CH₂CH₂CH₃)—CH₂(OH), CH₂(OH)—CH(O—C(O)—CH₂CH₂CH₂CH₂CH₂CH₂CH₂CH₂CH₂CH₃)—CH₂(O—C(O)—CH₂CH₂CH₂CH₂CH₂CH₂CH₂CH₂CH₂CH₃), CH₂(O—C(O)—CH₂CH₂CH₂CH₂CH₂CH₂CH₂CH₂CH₂CH₃)—CH(OH)—CH₂(O—C(O)—CH₂CH₂CH₂CH₂CH₂CH₂CH₂CH₂CH₂CH₃), CH₂(O—C(O)—CH₂CH₂CH₂CH₂CH₂CH₂CH₂CH₂CH₂CH₃)—CH(O—C(O)—CH₂CH₂CH₂CH₂CH₂CH₂CH₂CH₂CH₂CH₃)—CH₂(O—C(O)—CH₂CH₂CH₂CH₂CH₂CH₂CH₂CH₂CH₂CH₃), or mixtures of said substances.

Preferred cleaning-agent compositions according to the present invention are characterized in that they contain one or more mono- and/or di- and/or triesters of glycerol with methanoic acid and/or ethanoic acid and/or propanoic acid and/or butanoic acid, by preference one or more mono- and/or di- and/or triesters of glycerol with ethanoic acid (glycerol acetate), and in particular glycerol triacetate. All of the glycerol esters described above in terms of formulas, and mixtures thereof, are particularly suitable according to the present invention.

A preferred subject of the present invention is a liquid cleaning-agent composition containing a) 35 to 95 wt % hydroxy mixed ethers of the formula
R′—O—[CH₂CH(R³)O]ₓ—[CH₂CH(OH)]—R²
in which R¹ and R² can be different or identical,
R¹ denoting a linear or branched, saturated or unsaturated, aliphatic or aromatic hydrocarbon radical having 1 to 30 carbon atoms, or mixtures thereof, R² denoting a linear or branched, saturated or unsaturated, aliphatic or aromatic hydrocarbon radical having 1 to 30 carbon atoms, which optionally contains up to 5 hydroxy and/or up to 3 ether functions, R³ denoting H or a methyl, ethyl, n-propyl, isopropyl, n-butyl, 2-butyl, or 2-methylbutyl radical, such that when x≧2, each R³ can be different, and x denoting values greater than 1; and
b) 5 to 65 wt % of one or more mono- and/or di- and/or triesters of glycerol with ethanoic acid (glycerol acetate), in particular 5 to 65 wt % glycerol triacetate.

The combination of the hydroxy mixed ethers with the stabilizers indicated brings about a lowering of the melting point of the composition as compared with the hydroxy mixed ethers that are used. As a consequence, the agents according to the present invention solidify at temperatures that are well below room temperature. The resulting agents exhibit a clear-rinsing performance in automatic dishwashing processes that is enhanced as compared with agents of the existing art.

In preferred embodiments of the present invention, the weight ratio of hydroxy mixed ethers to the mono- and/or di- and/or triesters of glycerol with C₁₀ monocarboxylic acids that are used is between 20:1 and 1:2, by preference between 15:1 and 1:1.75, particularly preferably between 10:1 and 1:1.5, very particularly preferably between 5:1 and 1:1.25, and in particular between 2.5:1 and 1:1.

A preferred subject of the present invention is a liquid cleaning-agent composition containing a) 35 to 95 wt % hydroxy mixed ethers of the formula
R¹—O—[CH₂CH(R³)O]ₓ—[CH₂CH(OH)]—R²
in which R¹ and R² can be different or identical,
R¹ denoting a linear or branched, saturated or unsaturated, aliphatic or aromatic hydrocarbon radical having 1 to 30 carbon atoms, or mixtures thereof, R² denoting a linear or branched, saturated or unsaturated, aliphatic or aromatic hydrocarbon radical having 1 to 30 carbon atoms, which optionally contains up to 5 hydroxy and/or up to 3 ether functions, R³ denoting H or a methyl, ethyl, n-propyl, isopropyl, n-butyl, 2-butyl, or 2-methylbutyl radical, such that when x≧2, each R³ can be different, and x denoting values greater than 1; and
b) 5 to 65 wt % of one or more mono- and/or di- and/or triesters of glycerol with C₁₋₁₀ monocarboxylic acids,
   the weight ratio of hydroxy mixed ethers to the mono- and/or di- and/or triesters of glycerol with C₁₋₁₀ monocarboxylic acids that are used being between 20:1 and 1:2, by preference between 15:1 and 1:1.75, particularly preferably between 10:1 and 1:1.5, very particularly preferably between 5:1 and 1:1.25, and in particular between 2.5:1 and 1:1.

The subject matter of the present invention is, in a first embodiment, liquid nonaqueous cleaning-agent compositions for automatic dishwashing.

“Nonaqueous” is to be understood, in the context of this invention, as a state in which the free water content in the agents is well below 10 wt %, based on the agent. It is preferred that the cleaning-agent compositions according to the present invention contain less than 7.5 wt % free water, by preference less than 5 wt %, and in particular less than 2.5 wt % free water.

Water can accordingly be introduced into the agent substantially only in chemically and/or physically bound form or as a constituent of the raw materials or compounds present as solids, but not as a liquid, solution, or dispersion. Advantageously, the compositions according to the present invention have, in total, a water content of no more than 15 wt %, preferably no more than 10 wt %, and in particular no more than 5 wt %.

Nonaqueous, especially organic, solvents can be contained in the agents according to the present invention as further constituents. These solvents include, among others, ethylene glycol, propylene glycol, diethylene glycol, dipropylene glycol, triethylene glycol, polyethylene glycols and polypropylene glycols, ethanol, n- or i-propanol, butanols, glycol, propane- or butanediol, glycerol, glycerol carbonate, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl, or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether, propylene carbonate, and mixtures of these solvents. The aforesaid organic solvents are used preferably in quantities of less than 15 wt %, by preference less than 10 wt %, particularly preferably less than 5 wt %, very particularly preferably less than 2 wt %, and in particular less than 1 wt %, based on the entire agent. Particularly preferred agents according to the present invention are free of nonaqueous organic solvents.

A preferred subject of the present invention is a liquid cleaning-agent composition containing a) 35 to 95 wt % hydroxy mixed ethers of the formula
R¹—O—[CH₂CH(R³)O]ₓ—[CH₂CH(OH)]—R²
in which R¹ and R² can be different or identical,
R¹ denoting a linear or branched, saturated or unsaturated, aliphatic or aromatic hydrocarbon radical having 1 to 30 carbon atoms, or mixtures thereof, R² denoting a linear or branched, saturated or unsaturated, aliphatic or aromatic hydrocarbon radical having 1 to 30 carbon atoms, which optionally contains up to 5 hydroxy and/or up to 3 ether functions, R³ denoting H or a methyl, ethyl, n-propyl, isopropyl, n-butyl, 2-butyl, or 2-methylbutyl radical, such that when x≧2, each R³ can be different, and x denoting values greater than 1;
b) 5 to 65 wt % of one or more mono- and/or di- and/or triesters of glycerol with C₁₋₁₀ monocarboxylic acids; and
c) less than 15 wt %, by preference less than 10 wt %, particularly preferably less than 5 wt %, very particularly preferably less than 2 wt %, and in particular less than 1 wt % of organic solvents selected from the group of ethylene glycol, propylene glycol, diethylene glycol, dipropylene glycol, triethylene glycol, polyethylene glycols and polypropylene glycols, ethanol, n- or i-propanol, butanols, glycol, propane- or butanediol, glycerol, glycerol carbonate, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, di-ethylene glycol ethyl ether, propylene glycol methyl, ethyl, or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether, propylene carbonate.

Particularly preferred according to the present invention, in summary, are cleaning-agent compositions made up of
a) 35 to 94.8 wt % hydroxy mixed ethers of the formula
   R¹—O—[CH₂CH(R³)O]ₓ—[CH₂CH(OH)]—R²
   in which R¹ and R² can be different or identical,
   R¹ denoting a linear or branched, saturated or unsaturated, aliphatic or aromatic hydrocarbon radical having 1 to 30 carbon atoms, or mixtures thereof, R² denoting a linear or branched, saturated or unsaturated, aliphatic or aromatic hydrocarbon radical having 1 to 30 carbon atoms, which optionally contains up to 5 hydroxy and/or up to 3 ether functions, R³ denoting H or a methyl, ethyl, n-propyl, isopropyl, n-butyl, 2-butyl, or 2-methylbutyl radical, such that when x≧2, each R³ can be different, and x denoting values greater than 1; and
b) 5 to 60 wt % of one or more mono- and/or di- and/or triesters of glycerol with C₁₋₁₀ monocarboxylic acids;
c) 0.1 to 10 wt % water;
d) 0.005 to 0.1 wt % dye.

In addition to the clear-rinsing properties of the compositions according to the present invention, it can be desirable to ensure silver protection and/or protection from glass corrosion during the automatic dishwashing operation. For that purpose, corrosion inhibitors from the group of the silver corrosion inhibitors and/or glass corrosion inhibitors are optionally added to the agent according to the present invention.

Preferably the corrosion inhibitor content in the agents according to the present invention is 0.01 to 15 wt %, by preference 0.1 to 10 wt %, preferably 0.2 to 5 wt %, particularly preferably 0.25 to 2.5 wt %, and in particular 0.25 to 2 wt %, based on the entire agent.

The composition according to the present invention is utilized, inter alia, as a special agent in the area of corrosion protection. For these applications, it is preferred if the concentration of the aforesaid corrosion inhibitors is between 1 and 25 wt %, by preference between 1.5 and 20 wt %, particularly preferably between 2 and 15 wt %, and in particular between 2 and 10 wt %.

The weight ratio between hydroxy mixed ethers and corrosion agents is, in agents according to the present invention, preferably between 9000:1 and 2:1, particularly preferably between 1000:1 and 10:1, and in particular between 280:1 and 25:1.

The esters of glycerol with C₁₋₁₀ monocarboxylic acids by preference exhibit a weight ratio to the corrosion agents of between 6000:1 and 1:5, preferably between 1000:1 and 3:1, and in particular between 180:1 and 15:1.

The known substances of the existing art are usable as corrosion agents. In general, silver protection agents can be selected principally from the group of the triazoles, the benzotriazoles, the bisbenzotriazoles, the aminotriazoles, the alkylaminotriazoles, and the transition-metal salts or complexes. Benzotriazole and/or alkylaminotriazole are particularly preferred for use. The following can be mentioned as examples of the 3-amino-5-alkyl-1,2,4-triazoles preferred for use according to the present invention: propyl-, butyl-, pentyl-, -heptyl-, octyl-, nonyl-, decyl-, undecyl-, dodecyl-, isononyl-, versatic-10 acid alkyl-, phenyl-, p-tolyl-, (4-tert. butylphenyl)-, (4-methoxyphenyl)-, (2-, -3-, -4-pyridyl)-, (2-thienyl)-, (5-methyl-2-furyl)-, (5-oxo-2-pyrrolidinyl)-, 3-amino-1,2,4-triazole. In dishwashing agents, the alkylamino-1,2,4-triazoles or their physiologically acceptable salts are used at a concentration from 0.001 to 10 wt %, by preference 0.0025 to 2 wt %, particularly preferably 0.01 to 0.04 wt %. Preferred acids for salt formation are hydrochloric acid, sulfuric acid, phosphoric acid, carbonic acid, sulfinurous acid, organic carboxylic acids such as acetic, glycolic, citric, succinic acid. 5-pentyl, 5-heptyl, 5-nonyl, 5-undecyl, 5-isononyl, 5-versatic-10 acid alkyl-3-amino-1,2,4-triazoles, and mixtures of these substances, are very particularly effective.

Cleaner formulations moreover often comprise active chlorine-containing agents that agents can greatly decrease the corrosion of silver surfaces. In chlorine-free cleaners, oxygen- and nitrogen-containing organic redox-active compounds are used in particular, such as di- and trivalent phenols, e.g. hydroquinone, catechol, hydroxyhydroquinone, gallic acid, phloroglucine, pyrogallol, and derivatives of these classes of compounds. Salt-like and complex-like inorganic compounds, such as salts of the metals Mn, Ti, Zr, Hf, V, Co, and Ce, are also often used. Preferred in this context are the transition-metal salts that are selected from the group of the manganese and/or cobalt salts and/or complexes, particularly preferably the cobalt(ammine) complexes, cobalt(acetate) complexes, cobalt(carbonyl) complexes, the chlorides of cobalt or manganese, and manganese sulfate. Zinc compounds can also be used to prevent corrosion of the items being washed.

Instead of or in addition to the silver protection agents described above, for example the benzotriazoles, redox-active substances can be used. These substances are preferably inorganic redox-active substances from the group of the manganese, titanium, zirconium, hafnium, vanadium, cobalt, and cerium salts and/or complexes, the metals preferably being present in one of the oxidation stages II, III, IV, V, or VI.

The metal salts or metal complexes that are used should be at least partially soluble in water. The counterions suitable for salt formation comprise all usual singly, doubly, or triply negatively charged inorganic anions, e.g. oxide, sulfate, nitrate, fluoride, but also organic anions such as, for example, stearate.

Metal complexes for purposes of the invention are compounds that comprise a central atom and one or more ligands, as well as, if applicable, additionally one or more of the aforementioned anions. The central atom is one of the aforementioned metals in one of the aforementioned oxidation stages. The ligands are neutral molecules or anions that are unidentate or multidentate; the term “ligand” for purposes of the invention is explained in more detail in, for example, “Römpp Chemie Lexikon,” Georg Thieme Verlag Stuttgart/New York, 9th edition, 1990, page 2507. If the charge of the central atom and the charge of the ligand(s) in a metal complex do not add up to zero, charge equalization is ensured by either one or more of the aforementioned anions or one or more cations, e.g. sodium, potassium, ammonium ions, depending on whether a cationic or anionic charge excess exists. Suitable complexing agents are, for example, citrate, acetyl acetonate, or 1-hydroxyethane-1,1-diphosphonate.

The definition of “oxidation stage” commonly used in chemistry is provided, for example, in “Römpp Chemie Lexikon,” Georg Thieme Verlag Stuttgart/New York, 9th edition, 1991, page 3168.

Particularly preferred metal salts and/or metal complexes are selected from the group of MnSO₄, Mn(II) citrate, Mn(II) stearate, Mn(II) acetyl acetonate, Mn(II)-[1-hydroxyethane-1,1-diphosphonate], V₂O₅, V₂O₄, VO₂, TiOSO₄, K₂ TiF₆, K₂ZrF₆, CoSO₄, Co(NO₃)₂, Ce(NO₃)₃, and mixtures thereof, so that metal salts and/or metal complexes selected from the group of MnSO₄, Mn(II) citrate, Mn(I) stearate, Mn(II) acetyl acetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ are used with particular advantage.

These metal salts or metal complexes are, in general, commercially available substances that can be used without prior purification in the washing or cleaning agents according to the present invention for purposes of silver corrosion protection. For example, the mixture of pentavalent and tetravalent vanadium (V₂O₅, VO₂, V₂O₄) known from SO₃ production (contact method) is suitable, as is the titanyl sulfate TiOSO₄ resulting from dilution of a Ti(SO₄)₂ solution.

The inorganic redox-active substances, in particular metal salts or metal complexes, are preferably coated, i.e. completely covered with a material that is watertight but easily soluble at cleaning temperatures, in order to prevent their premature decomposition or oxidation during storage. Preferred coating materials, which are applied using known methods, e.g. Sandwik melt-coating methods from the food industry, are paraffins, microcrystalline waxes, waxes of natural origin such as carnauba wax, candelilla wax, beeswax, higher-melting-point alcohols such as, for example, hexadecanol, soaps, or fatty acids. The coating material that is solid at room temperature is applied in the molten state onto the material to be coated, for example by shooting fine particles of material to be coated, in a continuous stream, through a likewise continuously generated spray-mist zone of the molten coating material. The melting point must be selected so that the coating material easily dissolves or rapidly melts during silver treatment. The melting point should ideally be in the range between 45° C. and 65° C., and preferably in the range 50° C. to 60° C.

Glass corrosion inhibitors prevent the occurrence of clouding, smearing, and scratches, but also iridescence, of the glass surface of automatically washed glassware. Preferred glass corrosion inhibitors derive from the group of the magnesium and/or zinc salts and/or magnesium and/or zinc complexes.

A preferred class of compounds that can be used in order to prevent glass corrosion is insoluble zinc salts.

Insoluble zinc salts for purposes of this preferred embodiment are zinc salts that possess a solubility of, at maximum, 10 grams of zinc salt per liter of water at 20° C. Examples of insoluble zinc salts that are particularly preferred according to the present invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The addition of zinc nitrate hexahydrate is likewise preferred.

The aforesaid zinc compounds are used by preference in quantities that bring about a zinc ion content in the agents of between 0.02 and 10 wt %, by preference between 0.1 and 5.0 wt %, and in particular between 0.2 and 1.0 wt %, based in each case on the entire glass corrosion inhibitor-containing agent. The agents' exact content of zinc salt or salts is, of course, dependent on the type of zinc salts: the lower the solubility of the zinc salt used, the higher its concentration should be in the agents.

Because the insoluble zinc salts remain for the most part unchanged during the dishwashing process, the particle size of the salts is a criterion requiring care so that the salts do not adhere to glassware or to machine parts. Agents in which the insoluble zinc salts have a particle size below 1.7 millimeters are preferred here.

When the maximum particle size of the insoluble zinc salts is below 1.7 mm, there is no risk of insoluble residues in the dishwasher. In order further to minimize the danger of insoluble residues, the insoluble zinc salt preferably has an average particle size that is well below that value, for example an average particle size of less than 250 μm. This once again is all the more applicable the lower the solubility of the zinc salt. In addition, the glass corrosion-inhibiting effectiveness rises with decreasing particle size. For very poorly soluble zinc salts, the average particle size is preferably below 100 μm. It can be even lower for even more poorly soluble salts; for the very poorly soluble zinc oxide, for example, average particle sizes below 60 μm are preferred.

A further preferred class of compounds is magnesium and/or zinc salt(s) of at least one monomeric and/or polymeric organic acid. The effect of these is that even with repeated use, the surfaces of washed glassware are not modified in corrosive fashion; in particular, no clouding, smearing, or scratching, but also no iridescence, of the glass surfaces are caused.

Although all magnesium and/or zinc salt(s) of monomeric and/or polymeric organic acids can be used, the magnesium and/or zinc salts of monomeric and/or polymeric organic acids from the groups of the unbranched saturated or unsaturated monocarboxylic acids, the branched saturated or unsaturated monocarboxylic acids, the saturated and unsaturated dicarboxylic acids, the aromatic mono-, di- and tricarboxylic acids, the sugar acids, the hydroxy acids, the oxo acids, the amino acids, and/or the polymeric carboxylic acids are nevertheless preferred.

The spectrum of zinc salts of organic acids, preferably of organic carboxylic acids, preferred according to the present invention extends from salts that are poorly soluble or insoluble in water, i.e. exhibit a solubility below 100 mg/l, by preference below 10 mg/l, in particular below 0.01 mg/l, to those salts that exhibit a solubility in water above 100 mg/l, by preference above 500 mg/l, particularly preferably above 1 g/L, and in particular above 5 g/L (all solubilities at a 20° C. water temperature). Zinc citrate, zinc oleate, and zinc stearate, for example, belong to the first group of zinc salts; zinc formate, zinc acetate, zinc lactate, and zinc gluconate, for example, belong to the group of the soluble zinc salts.

With particular preference, at least one zinc salt of an organic carboxylic acid, particularly preferably a zinc salt from the group of zinc stearate, zinc oleate, zinc gluconate, zinc acetate, and/or zinc citrate, is used as a glass corrosion inhibitor. Zinc ricinoleate, zinc abietate, and zinc oxalate are also preferred.

In the context of the present invention, the zinc salt content of cleaning agents is by preference between 0.1 and 5 wt %, preferably between 0.2 and 4 wt %, and in particular between 0.4 and 3 wt %, or the content of zinc in oxidized form (calculated as Zn²⁺) is between 0.01 and 1 wt %, by preference between 0.02 and 0.5 wt %, and in particular between 0.04 and 0.2 wt %, based in each case on the total weight of the glass corrosion inhibitor-containing agent.

In addition to blackish discolorations on silverware and whitish deposits on glassware, discolorations on stainless steel, e.g. cookware, may be observed on items that have been repeated washed automatically. This stainless steel corrosion can be counteracted by the addition of cationic polymers to the agent according to the present invention.

The washing or cleaning agent according to the present invention preferably contains polymers having cationic functional groups, belonging to the group of the cationic polymers.

Polymers having a cationic monomer unit are used in the cleaning-agent composition according to the present invention preferably in a proportion from 0.01 to 7.5 wt %, preferably 0.02 to 5 wt %, particularly preferably 0.03 to 2.5 wt %, very particularly preferably 0.04 to 1 wt %, and in particular 0.05 to 1 wt %, based on the entire agent.

“Cationic polymers” for purposes of the present invention are polymers that carry a positive charge in the polymer molecule. This can be implemented, for example, by way of (alkyl)ammonium groups or other positively charged groups present in the polymer chain. Particularly preferred cationic polymers derive from the groups of the quaternized cellulose derivatives, the polysiloxanes having quaternary groups, the cationic guar derivatives, the polymeric dimethyldiallylammonium salts and their copolymers with esters and amides of acrylic acid and methacrylic acid, the copolymers of vinylpyrrolidone with quaternized derivatives of dialkylaminoacrylate and -methacrylate, the vinylpyrrolidone/methoimidazolinium chloride copolymers, the quaternized poly(vinylalcohols), or the polymers known by the INCI designations Polyquaternium 2, Polyquaternium 17, Polyquaternium 18, and Polyquaternium 27.

Preferred or cleaning-agent compositions are characterized in that they contain a polymer that comprises monomer units of the formula R¹R²C═CR³R⁴ in which each R¹, R², R³, R⁴ radical is selected, mutually independently, from hydrogen, a derivatized hydroxy group, C₁₋₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternized N atom, or at least one amino group having a positive charge in the sub-range of the pH range from 2 to 11, or salts thereof, with the stipulation that at least one R¹, R², R³, R⁴ radical is a heteroatomic organic group having at least one positive charge without charged nitrogen, at least one quaternized N atom, or at least one amino group having a positive charge.

Cationic or amphoteric polymers that are particularly preferred in the context of the present application contain as a monomer unit a compound of the general formula 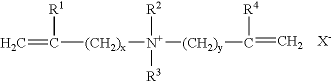
in which R¹ and R⁴, mutually independently, denote H or a linear or branched hydrocarbon radical having 1 to 6 carbon atoms; R² and R³, mutually independently, denote an alkyl, hydroxyalkyl, or aminoalkyl group in which the alkyl radical is linear or branched and comprises between 1 and 6 carbon atoms, this preferably being a methyl group; x and y, mutually independently, denote integers between 1 and 3. X⁻ represents a counterion, preferably a counterion from the group of chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate, or mixtures thereof.

Preferred R¹ and R⁴ radicals in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Very particularly preferred are polymers that comprise a cationic monomer unit of the above general formula in which R¹ and R⁴ denote H, R² and R³ denote methyl, and x and y are each 1. The corresponding monomer units of the formula 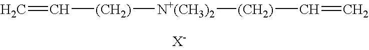
are also referred to, in the case in which X⁻=chloride, as DADMAC (diallyldimethylammonium chloride).

Further particularly preferred cationic polymers contain a monomer unit of the general formula 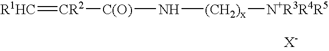
in which R¹, R², R³, R⁴ and R⁵, mutually independently, denote a linear or branched, saturated or unsaturated alkyl or hydroxyalkyl radical having 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x denotes a whole number between 1 and 6.

Very particularly preferred in the context of the present application are polymers that comprise a cationic monomer unit of the above general formula in which R¹ denotes H and R², R³, R⁴, and R⁵ denote methyl, and x denotes 3. The corresponding monomer units of the formula 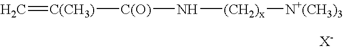
are also referred to, in the case where [symbol] =chloride, as MAPTAC (methyacrylamidopropyltrimethylammonium chloride).

It is preferred according to the present invention to use polymers that contain, as monomer units, diallyldimethylammonium salts and/or acrylamidopropyltrimethylammonium salts.

The aforementioned amphoteric polymers comprise not only cationic groups but also anionic groups or monomer units. Anionic monomer units of this kind derive, for example, from the group of the linear or branched, saturated or unsaturated carboxylates, the linear or branched, saturated or unsaturated phosphonates, the linear or branched, saturated or unsaturated sulfates, or the linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid, and their derivatives, the allylsulfonic acids such as, for example, allyloxybenzenesulfonic acid and methallylsulfonic acid, or the allylphosphonic acids.

Amphoteric polymers preferred for use derive from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkylmethacrylate/alkylaminoethylmethacrylate/alkylmethacrylate copolymers, and the copolymers of unsaturated carboxylic acids, cationically derivatized unsaturated carboxylic acids and, if applicable, further ionic or nonionogenic monomers.

In a particularly preferred embodiment of the present invention, the polymers are present in prepackaged form. Suitable for packaging of the polymers are, among others:
encapsulation of the polymers by means of water-soluble or water-dispersible coating agents, preferably by means of water-soluble or water-dispersible natural or synthetic polymers;
encapsulation of the polymers by means of water-insoluble, meltable coating agents, preferably by means of water-insoluble coating agents from the group of the waxes or paraffins having a melting point above 30° C.;
cogranulation of the polymers with inert carrier materials, by preference with carrier materials from the group of the substances having washing or cleaning activity, particularly preferably from the group of the builders (detergency builders) or cobuilders.

The agents according to the present invention optionally contain 0.001 to 3 wt %, by preference 0.05 to 2.5 wt %, and in particular 0.1 to 2 wt % of water-binding agents from the group of urea, sorbitol, trimethylamine, oxalic acid, boric acid, borax, dimethylol urea, glyoxal, diepoxides, divinylsulfones, and/or the water-soluble formaldehyde derivatives.

Liquid agents according to the present invention can furthermore contain water-soluble builders. Water-soluble builders are used in the compositions according to the present invention chiefly to bind calcium and magnesium. The builders are added in the context of the invention preferably in quantities below 15 wt %, by preference below 12 wt %, particularly preferably below 9 wt %, and in particular from 0.01 to 6 wt %, based in each case on the cleaning-agent composition. Liquid agents that are particularly preferred according to the present invention are free of builders. Examples of suitable builders are the low-molecular-weight polycarboxylic acids and their salts, the homopolymeric and copolymeric polycarboxylic acids and their salts, the carbonates, phosphates, and sodium and potassium silicates. Low-molecular-weight polycarboxylic acids for purposes of the present invention are substances that carry two or more carboxyl functions and have molar weights below 2000. Included in this group are, in particular, the acids recited below and their salts: tartaric acid, succinic acid, malonic acid, adipic acid, maleic acid, fumaric acid, oxalic acid, and in particular citric acid. Sokalan® DCS (trademark of BASF), a mixture of succinic acid (max. 31 wt %), glutaric acid (max. 50 wt %) and adipic acid (max. 33 wt %), is commercially obtainable and likewise preferably usable in the context of the present invention. For the cleaning agents according to the present invention, trisodium citrate and/or pentasodium tripolyphosphate and silicate builders from the class of the alkali disilicates are preferably used. In general, in the context of the alkali-metal salts the potassium salts are to be preferred over the sodium salts, since they often possess greater water solubility. Preferred water-soluble builders are, for example, tripotassium citrate, potassium carbonate, and the potassium water glasses.

Particularly preferred cleaning-agent compositions contain, as water-soluble builders, phosphates, preferably alkali-metal phosphates, with particular preference for pentasodium or pentapotassium triphosphate (sodium or potassium tripolyphosphate).

“Alkali-metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits, and furthermore contribute to cleaning performance.

Sodium dihydrogenphosphate, NaH₂PO₄, exists as the dihydrate (density 1.91 gcm⁻³, melting point 60°) and as the monohydrate (density 2.04 gcm⁻³). Both salts are white powders that are very easily soluble in water and that lose their water of crystallization upon heating and transition at 200° C. into the weakly acid diphosphate (disodium hydrogendiphosphate, Na₂H₂P₂O₇), and at higher temperature into sodium trimetaphosphate (Na₃P₃O₉) and Maddrell salt (see below). NaH₂PO₄ reacts in acid fashion; it is created when phosphoric acid is adjusted with sodium hydroxide to a pH of 4.5 and the mash is spray-dried. Potassium dihydrogenphosphate (primary or unibasic potassium phosphate, potassium diphosphate, KDP), KH₂PO₄, is a white salt of density 2.33 gcm⁻³, has a melting point of 253° [decomposing to form potassium polyphosphate (KPO₃)ₓ], and is easily soluble in water.

Disodium hydrogenphosphate (secondary sodium phosphate), Na₂HPO₄, is a colorless, very easily water-soluble crystalline salt. It exists anyhdrously and with 2 mol (density 2.066 gcm⁻³, water lost at 95°), 7 mol (density 1.68 gcm⁻³, melting point 48° with loss of 5H₂O), and 12 mol of water (density 1.52 gcm⁻³, melting point 35° with loss of 5H₂O); it becomes anhydrous at 100° and when further heated transitions into the diphosphate Na₄P₂O₇. Disodium hydrogenphosphate is produced by the neutralization of phosphoric acid with a soda solution using phenolphthalein as indicator. Dipotassium hydrogenphosphate (secondary or dibasic potassium phosphate), K₂HPO₄, is an amorphous white salt that is easily soluble in water.

Trisodium phosphate (tertiary sodium phosphate), Na₃PO₄, exists as colorless crystals that as the dodecahydrate have a density of 1.62 gcm⁻³ and a melting point of 73-76° C. (decomposition), as the decahydrate (corresponding to 19-20% P₂O₅) a melting point of 100° C., and in anhydrous form (corresponding to 39-40% P₂O₅) a density of 2.536 gcm⁻³. Trisodium phosphate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning-agent industry.

Tetrasodium diphosphate (sodium pyrophosphate), Na₄P₂O₇, exists in anhydrous form (density 2.534 gcm⁻³, melting point 988°, also indicated as 880°) and as the decahydrate (density 1.815-1.836 gcm⁻³, melting point 94° with loss of water). Both substances are colorless crystals that are soluble in water with an alkaline reaction. Na₄P₂O₇ is created when disodium phosphate is heated to >200°, or by reacting phosphoric acid with soda in the stoichiometric ratio and dewatering the solution by spraying. The decahydrate complexes heavy-metal salts and hardness constituents, and therefore decreases water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 25°.

Condensation of NaH₂PO₄ or KH₂PO₄ yields higher-molecular-weight sodium and potassium phosphates, within which a distinction can be made between cyclic representatives (the sodium and potassium metaphosphates) and chain types (the sodium and potassium polyphosphates). For the latter in particular, a number of designations are in use: fused or thermal phosphates, Graham salt, Kurrol's salt, and Maddrell salt. All the higher sodium and potassium phosphates are together referred to as “condensed” phosphates.

The technically important pentasodium triphosphate Na₅P₃O₁₀ (sodium tripolyphosphate) is a white, water-soluble, non-hygroscopic salt, crystallizing anhydrously or with 6H₂O, of the general formula NaO—[P(O)(ONa)—O]ₙ—Na, where n=3. Approximately 17 g of the salt containing no water of crystallization dissolves in 100 g of water at room temperature, approx. 20 g at 60° C., and approx. 32 g at 100°; after the solution is heated to 100° for two hours, approx. 8% orthophosphate and 15% disphosphate are produced by hydrolysis. In the production of pentasodium triphosphate, phosphoric acid is reacted with a soda solution or sodium hydroxide in the stoichiometric ratio, and the solution is dewatered by spraying. Like Graham salt and sodium diphosphate, pentasodium triphosphate dissolves many insoluble metal compounds (including lime soaps, etc.).

Sodium tripolyphosphate can be contained in the agents according to the present invention, but it is also possible to dispense with its use and to utilize other water-soluble builders, in particular potassium phosphates.

Pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the washing and cleaning agent industry.

In summary, cleaning-agent compositions according to the present invention that contain as water-soluble builders citrates and/or phosphates, by preference alkali-metal phosphates with particular preference for pentasodium or pentapotassium triphosphate (sodium or potassium tripolyphosphate), are preferred.

It may be preferred to utilize citrates in mixtures with phosphates, or also to dispense entirely with the addition of citrates.

A preferred subject of the present invention is a liquid cleaning-agent composition containing
a) 35 to 95 wt % hydroxy mixed ethers of the formula
   R¹—O—[CH₂CH(R³)O]ₓ—[CH₂CH(OH)]—R²
   in which R¹ and R² can be different or identical,
   R¹ denoting a linear or branched, saturated or unsaturated, aliphatic or aromatic hydrocarbon radical having 1 to 30 carbon atoms, or mixtures thereof, R² denoting a linear or branched, saturated or unsaturated, aliphatic or aromatic hydrocarbon radical having 1 to 30 carbon atoms, which optionally contains up to 5 hydroxy and/or up to 3 ether functions, R³ denoting H or a methyl, ethyl, n-propyl, isopropyl, n-butyl, 2-butyl, or 2-methylbutyl radical, such that when x≧2, each R³ can be different, and x denoting values greater than 1;
b) 5 to 65 wt % of one or more mono- and/or di- and/or triesters of glycerol with C₁₋₁₀ monocarboxylic acids; and
c) less than 15 wt %, by preference less than 12 wt %, particularly preferably less than 9 wt %, and in particular 0.01 to 6 wt %, of builders.

The compositions according to the present invention are preferably present in clear, transparent form. “Transparency” for purposes of this invention is to be understood to mean that the transmissivity within the visible spectrum of light (410 to 800 nm) is greater than 20%, by preference greater than 30%, extremely preferably greater than 40%, and in particular greater than 50%. As soon as a wavelength of the visible spectrum of light exhibits a transmissivity greater than 20%, it is therefore to be considered transparent for purposes of the invention.

Coloring of the cleaning-agent composition also enhances the attractiveness of the final product. It is preferred, for example, to tint the composition with blue, red, yellow, green, violet, orange, or even turquoise dyes and/or dye mixtures. It is conceivable in this context for the entire agent to be tinted in one color. Likewise possible, however, is a division of the agent into different receiving chambers of the receiving container explained below, and different coloring of the chamber contents, i.e. the individual agent portions.

The cleaning-agent compositions according to the present invention are preferably encased in a water-soluble or water-dispersible material, i.e. introduced into a water-soluble or water-dispersible container. The packaging material is preferably transparent, and can be tinted as necessary. An air bubble is preferably contained in the packaged liquid composition. This increases the attractiveness of the product and allows the consumer to recognize directly that the agent according to the present invention is a liquid. The consumer associates the liquid consistency of the agent with a rapid release of the active substances. The air bubble occupies by preference less than 20 vol %, preferably less than 15 vol %, particularly preferably between 1 and 10 vol %, and in particular between 2 and 8 vol % of the packaged liquid agent.

The water-soluble or water-dispersible containers are, in principle, accessible in any manner described in the existing art. Particularly preferred, however, are containers that were manufactured by the deep drawing method, the injection molding method, or the melt casting method. These containers preferably comprise more than one receiving chamber, particularly preferably more than two, and in particular more than three receiving chambers.

“Deep drawing” or “deep drawing methods” refers, in the context of the present application, to methods for processing packaging materials in which the latter, after optional pretreatment by way of heat and/or solvents and/or conditioning by way of relative humidities and/or temperatures modified with respect to ambient conditions, are shaped by means of a correspondingly shaped female die. The packaging can be introduced, for example as a panel or film, between the two parts of a tool (the positive and negative) and deformed by pressing those parts together; but the deformation can also be accomplished without the use of a negative tool by the action of a vacuum and/or compressed air and/or the dead weight of enclosed washing or cleaning agent.

With regard to the deep drawing methods, a distinction can be made between methods in which the encasing material is guided horizontally into a shaping station and from there, in horizontal fashion, for filling and/or sealing and/or separation; and methods in which the encasing material is guided over a continuously circulating female die shaping roller (if applicable, optionally having a male die shaping roller, guided in the opposite direction, which guides the shaping plunger to the cavities of the female die shaping roller). The former process variant (the flat-bed process) can be operated both continuously and discontinuously; the process variant using a shaping roller is generally carried out continuously. All the aforesaid deep drawing methods are suitable for production of the agents preferred according to the present invention. The receiving cavities located in the female dies can be arranged “in line” or in offset fashion.

The water-soluble or water-dispersible containers can also be manufactured by injection molding. “Injection molding” refers to the reshaping of a molding compound in such a way that the compound for more than one injection molding operation, contained in a compound cylinder, is plastically softened under the action of heat, and flows under pressure through a nozzle into the hollow space of a previously closed tool. The method is applied principally to non-curable molding compounds that solidify in the tool by cooling. Injection molding is a very economical modern method for producing shaped objects without cutting, and is particularly suited for automated mass production. In practical operation, the thermoplastic molding compounds (powders, grains, cubes, pastes, etc.) are heated until liquefied (up to 180° C.), and are then injected under high pressure (up to 140 MPa) into closed, preferably water-cooled hollow molds having two parts, i.e. comprising an impression die (formerly called a female die) and a mandrel (formerly called a male die), where they cool and solidify. Piston and screw injection molding machines are usable. Water-soluble polymers such as, for example, the aforementioned cellulose ethers, pectins, polyethylene glycols, polyvinyl alcohols, polyvinylpyrrolidones, alginates, gelatins, or starch, are suitable as molding compounds (injection-molding compounds).

In a third preferred embodiment of the method according to the present invention, the melt casting method is used to manufacture the water-soluble or water-dispersible container. “Melt casting” refers to the reshaping of a molding compound in such a way that the compound preferably for more than one melt casting operation, contained in a compound cylinder, is plastically softened under the action of heat, and flows under pressure into the hollow space of a previously closed tool.

Like injection molding, melt casting is also preferably applied in a context of non-curable molding compounds that solidify in the tool by cooling (thermoplastics). The processing of thermosetting plastics and elastomers is, however, also possible; in this case, however, electrical heating of the tool is used in order to cure or vulcanize the injected material.

In the preferred method, the molding compounds are cast and subsequently solidify to yield a dimensionally stable molded element. The term “solidify” identifies any hardening mechanism that supplies, from a reshapable, preferably flowable mixture or a substance or compound of that kind, a body that is solid at room temperature, with no necessity for pressing or compacting forces. “Solidification” for purposes of the present invention is therefore, for example, the hardening, by cooling, of melts of substances that are solid at room temperature. “Solidification processes” for purposes of the present application are also the hardening of reshapable compounds by time-delayed binding of water, by evaporation of solvents, by chemical reaction, crystallization, etc., as well as the reactive curing of flowable powder mixtures to yield stable hollow bodies.

The manufacture of preferred molded elements is accomplished by pouring a molding compound into a shaping tool and then unmolding the solidified cast body, forming a (recessed) shaped element. Tools which comprise cavities that can be filled with pourable substances preferably serve as the “shaping tool.” Such tools can be embodied, for example, in the form of individual cavities but also in the form of plates having multiple cavities. In industrial methods, the individual cavities or cavity plates are preferably mounted on horizontally circulating conveyor belts that enable continuous or discontinuous transport of the cavities, for example, along a series of different workstations (e.g.: pouring, cooling, filling, sealing, unmolding, etc.).

Shaping of the aforesaid recesses is preferably achieved by subsequent pressing of a correspondingly shaped tool into the molding compound that has already flowed in. It is particularly preferred in this context that at the time at which the tool is pressed in, the viscosity of the molding compound has already risen by 1-50%, preferably 1-35%, in particular 1-20% as compared with the viscosity that the molding compound had upon flowing into the mold.

In general, all casing materials that can be processed by way of deep drawing methods, injection molding methods, or melt casting methods are usable in the method according to the present invention, although the use of water-soluble or water-dispersible packaging materials is preferred.

Some particularly preferred water-soluble or water-dispersible casing materials, which are suitable both for manufacturing the receiving chambers and for sealing them or using them as a separating layer, are listed below. The polymers cited can be used as a casing material both alone and in combination with one another or in combination with further substances, for example plasticizers, slip agents or lubricants, or solubilizers.
a) water-soluble nonionic polymers from the group of the
a1) polyvinylpyrrolidones,
a2) vinylpyrrolidone/vinyl ester copolymers,
a3) cellulose ethers
b) water-soluble amphoteric polymers from the group of the
b1) alkylacrylamide/acrylic acid copolymers
b2) alkylacrylamide/methacrylic acid copolymers
b3) alkylacrylamide/methylmethacrylic acid copolymers
b4) alkylacrylamide/acrylic acid/alkylaminoalkyl(meth)acrylic acid copolymers
b5) alkylacrylamide/methacrylic acid/alkylaminoalkyl(meth)acrylic acid copolymers
b6) alkylacrylamide/methylmethacrylic acid/alkylaminoalkyl(meth)acrylic acid copolymers
b7) alkylacrylamide/alkylmethacrylate/alkylaminoethylmethacrylate/alkylmeth-acrylate copolymers
b8) copolymers of
   b8i) unsaturated carboxylic acids
   b8ii) cationically derivatized unsaturated carboxylic acids
   b8iii) if applicable, further ionic or nonionogenic monomers
c) water-soluble zwitterionic polymers from the group of the
c1) acrylamidoalkyltrialkylammonium chloride/acrylic acid copolymers and their alkali and ammonium salts
c2) acrylamidoalkyltrialkylammonium chloride/methacrylic acid copolymers and their alkali and ammonium salts
c3) methacroylethyl betaine/methacrylate copolymers
d) water-soluble anionic polymers from the group of the
d1) vinyl acetate/crotonic acid copolymers
d2) vinylpyrrolidone/vinyl acrylate copolymers
d3) acrylic acid/ethyl acrylate/N-tert.butylacrylamide terpolymers
d4) graft polymers of vinyl esters, esters of acrylic acid or methacrylic acid alone or mixed, copolymerized with crotonic acid, acrylic acid, or methacrylic acid with polyalkylene oxides and/or polykalkylene glycols
d5) grafted and crosslinked copolymers from the copolymerization of
   d5i) at least one monomer of the nonionic type,
   d5ii) at least one monomer of the ionic type,
   d5iii) polyethylene glycol, and
   d5iv) a crosslinker
d6) copolymers obtained by copolymerization of at least one monomer of each of the following three groups:
   d6i) esters of unsaturated alcohols and short-chain saturated carboxylic acids and/or
      esters of short-chain saturated alcohols and unsaturated carboxylic acids,
   d6ii) unsaturated carboxylic acids,
   d6iii) esters of long-chain carboxylic acids and unsaturated alcohols and/or esters of the carboxylic acids of group d6ii) with saturated or unsaturated, straight-chain or branched C₈₋₁₈ alcohols
d7) terpolymers of crotonic acid, vinyl acetate, and an allyl or methallyl ester
d8) tetra- and pentapolymers of
   d8i) crotonic acid or allyloxyacetic acid
   d8ii) vinyl acetate or vinyl propionate
   d8iii) branched allyl or methallyl esters
   d8iv) vinyl ethers, vinyl esters, or straight-chain allyl or methallyl esters
d9) crotonic acid copolymers with one or more monomers from the group of ethylene, vinylbenzene, vinyl methyl ether, acrylamide, and their water-soluble salts
d10) terpolymers of vinyl acetate, crotonic acid, and vinyl esters of a saturated aliphatic monocarboxylic acid branched in the α-position
e) water-soluble cationic polymers from the group of the
e1) quaternized cellulose derivatives
e2) polysiloxanes having quaternized groups
e3) cationic guar derivatives
e4) polymeric dimethyldiallylammonium salts and their copolymers with esters and amides of acrylic acid and methacrylic acid
e5) copolymers of vinylpyrrolidone with quaternized derivatives of dialkylaminoacrylate and -methacrylate
e6) vinylpyrrolidone-methoimidazolinium chloride copolymers
e7) quaternized polyvinyl alcohol
e8) polymers listed under the INCI names Polyquaternium 2, Polyquaternium 17, Polyquaternium 18, and Polyquaternium 27.

Water-soluble polymers for purposes of the invention are those polymers that are soluble in water at more than 2.5 wt %.

In a preferred variant method, the container encompasses one or more water-soluble polymer(s), preferably a material from the group of (optionally acetalized) poly(vinyl alcohol) (PVAL), polyvinylpyrrolidone, polyethylene oxide, gelatin, cellulose, and derivatives and mixtures thereof.

In the context of the present invention, it is preferred that the casing material used in the method according to the present invention encompass at least in portions a poly(vinyl alcohol) whose degree of hydrolysis is 70 to 100 mol %, by preference 80 to 90 mol %, particularly preferably 81 to 89 mol %, and in particular 82 to 88 mol %. In a preferred embodiment, the first casing material used in the method according to the present invention encompasses at least 20 wt %, particularly preferably at least 40 wt %, very particularly preferably at least 60 wt %, and in particular at least 80 wt % of a poly(vinyl alcohol) whose degree of hydrolysis is 70 to 100 mol %, by preference 80 to 90 mol %, particularly preferably 81 to 89 mol %, and in particular 82 to 88 mol %.

Poly(vinyl alcohols) of a specific molecular-weight range are by preference used as materials for the containers, it being preferred according to the present invention that the casing material encompass a poly(vinyl alcohol) whose molecular weight is in the range from 10,000 to 100,000 gmol⁻¹, by preference from 11,000 to 90,000 gmol⁻¹, particularly preferably from 12,000 to 80,000 gmol⁻¹, and in particular from 13,000 to 70,000 gmol⁻¹.

The degree of polymerization of such preferred poly(vinyl alcohols) is between approximately 200 to approximately 1200, by preference between approximately 220 to approximately 1890, particularly preferably between approximately 240 to approximately 1680, and in particular between approximately 260 to approximately 1500.

The poly(vinyl alcohols) described above are widely available commercially, for example under the trademark Mowiol® (Clariant). Poly(vinyl alcohols) particularly suitable in the context of the present invention are, for example, Mowiol® 3-83, Mowiol® 4-88, Mowiol® 5-88, and Mowiol® 8-88.

Further poly(vinyl alcohols) that are particularly suitable as casing materials may be inferred from the table below:

| | Degree | Molar weight | Melting point |
|---|---|---|---|
| Designation | of hydrolysis (%) | (kDa) | (° C.) |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® | 30-28 | 23,600 | 100 |
| 5407 | | | |
| Gohsefimer ® | 41-51 | 17,700 | 100 |
| LL02 | | | |

Further poly(vinyl alcohols) suitable as casing materials are ELVANOL® 51-05, 52-22, 50-42, 85-82, 75-15, T-25, T-66, 90-50 (trademarks of Du Pont), ALCOTEX® 72.5, 78, B72, F80/40, F88/4, F88/26, F88/40, F88/47 (trademarks of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trademarks of Nippon Gohsei K.K.).

The water solubility of PVAL can be modified by subsequent treatment with aldehydes (acetalization) or ketones (ketalization). Poly(vinyl alcohols) that are acetalized or ketalized with the aldehyde or keto groups of saccharides or polysaccharides or mixtures thereof have proven to be particularly preferred and, because of their extremely good cold-water solubility, particularly advantageous. The reaction products of PVAL and starch are to be used in extremely advantageous fashion.

Examples of suitable water-soluble PVAL films are the PVAL films obtainable under the designation “SOLUBLON® 5” from Syntana Handelsgesellschaft E. Harke GmbH & Co. Their solubility in water can be adjusted to within one degree, and films of this product series are available that are soluble in the aqueous phase in all temperature ranges relevant for the application.

Casing materials that encompass a polymer from the group of starch and starch derivatives, cellulose and cellulose derivatives, in particular methyl cellulose, and mixtures thereof, are preferred in the context of the method according to the present invention.

In addition to pure starch, starch derivatives that are obtainable from starch by polymer-analogous reactions are also suitable in the context of the present invention for the production of water-soluble casings of the washing-agent, dishwashing-agent and cleaning-agent portions. Such chemically modified starches encompass, for example, products of esterification or etherification processes in which hydroxy hydrogen atoms were substituted. Starches in which the hydroxy groups have been replaced with functional groups that are not bound via an oxygen atom can also, however, be used as starch derivatives. Alkali starches, carboxymethyl starch (CMS), starch esters and ethers, and amino starches, for example, fall into the group of the starch derivatives.

Also usable in the context of the present invention as cellulose-based disintegration agents are cellulose derivatives that are obtainable from cellulose via polymer-analogous reactions. Such chemically modified celluloses comprise, for example, products of esterification or etherification processes in which hydroxy hydrogen atoms were substituted. Celluloses in which the hydroxy groups were replaced with functional groups that are not bound via an oxygen atom can also, however, be used as cellulose derivatives. Alkali celluloses, carboxymethyl cellulose (CMC), cellulose esters and ethers, and aminocelluloses, for example, fall into the group of the cellulose derivatives.

Meltable substances from the group of the fats and/or triglycerides and/or fatty acids and/or fatty alcohols and/or waxes and/or paraffins are, in particular, suitable as a matrix material for molded elements that are manufactured by melt solidification.

In the context of the present invention, it is preferred if the molded elements used as packaging additionally contain substances having washing activity, which are enclosed in the aforementioned matrix. It is preferred to fill a hollow body, having washing activity and serving as a packaging part, with the liquid composition according to the present invention. The filled hollow body is preferably then closed off with a water-soluble or water-dispersible film. If the liquid composition according to the present invention has a sufficiently high viscosity, sealing by means of a film can be omitted. Further agents, such as tablets or liquids/gels/powders packaged in water-soluble or water-dispersible film, can optionally be introduced into the hollow bodies before or after filling with the liquid composition.

The substances having washing activity are preferably present in the molded element as a dispersion. The water-soluble or water-dispersible polymers, in particular the water-soluble or water-dispersible nonionic polymers, are suitable by preference as dispersing agents. The dispersing agent can be both a single polymer and mixtures of different water-soluble or water-dispersible polymers. In a further preferred embodiment of the present invention, the dispersing agent or at least 50 wt % of the polymer mixture is made up of water-soluble or water-dispersible nonionic polymers from the group of the polyvinylpyrrolidones, vinylpyrrolidone/vinyl ester copolymers, cellulose ethers, poly(vinyl alcohols), polyalkylene glycols, in particular polyethylene glycol and/or polypropylene glycol.

Suitable as dispersed substances in the context of the present application are all substances having washing or cleaning activity that are solid at room temperature, but in particular substances having washing or cleaning activity from the group of the builders (builders and cobuilders), the polymers having washing or cleaning activity, the bleaching agents, the bleach activators, the glass corrosion protection agents, the silver protection agents, and/or the enzymes.

The automatic cleaning of tableware in household automatic dishwashers usually encompasses a pre-wash operation, a main washing operation, and a clear rinsing operation, which are interrupted by intermediate rinsing operations. In most machines, the pre-wash operation can be switched on for heavily soiled tableware but is selected by the consumer only in exceptional cases, so that in most machines a main washing operation, an intermediate rinsing operation with plain water, and a clear rinsing operation are performed. The temperature of the main washing operation varies between 40 and 65° C., depending on the machine model and the selection of program steps. In the clear rinsing operation, clear rinsing agent that usually contains nonionic surfactants as a principal constituent is introduced into the machine from a dispensing tank. Its purpose is chiefly to prevent lime spots and deposits on the washed tableware.

A subject of the present invention is a liquid composition that is used as a special agent in addition to the dishwashing agent and thus renders superfluous the introduction of clear rinsing agent into the dispensing tank. Because of the presentation of the compositions according to the present invention with and without corrosion inhibitors, it is possible to make protection against silver and/or glass corrosion available as necessary, with no need for the consumer to keep two different dishwashing agents on hand.

The liquid composition according to the present invention is used by preference in a dispensing unit of 5 to 30 g, particularly preferably 10 to 25 g, and in particular 15 to 25 g, or 5 to 40 ml, preferably 8 to 30 ml, and by preference 14 to 30 ml. Likewise preferred are dispensing units from 15 to 75 ml, by preference from 20 to 70 ml, and in particular from 30 to 60 ml. These are used in particular for less-concentrated compositions, i.e. when there is a lower concentration of nonionic surfactant in the liquid composition.

A further subject of the present invention is a combination product in which, in addition to the liquid composition, further agents having cleaning activity are contained, for example in the form of tablets and/or solid or liquid pouches. The agents are preferably introduced into containers having multiple receiving chambers. These so-called “2 in 1” products result in simplified handling and relieve the consumer of the task of additional dispensing of two different products (cleaning agent and clear rinsing agent).

In combination products, the liquid compositions according to the present invention account for by preference 10 to 90%, preferably 20 to 80%, particularly preferably 30 to 70%, and in particular 40 to 60% of the volume of the combination product. The weight proportion of the liquid composition in the combination product is by preference less than 80%, preferably less than 70%, particularly preferably less than 60%, and in particular between 20 and 50%.

There are a number of possibilities for the combination of the aforementioned presentation forms of solid and liquid cleaning agents with the liquid compositions according to the present invention. Some preferred embodiments are described in the tables below. The receiving chambers filled with liquid, powder, or granules preferably comprise a seal. For the receiving chambers filled with compactates, extrudates, molded elements or dimensionally stable gels, the seal is optional but is preferred.

The liquid cleaning-agent compositions according to the present invention are referred to below as an “inventive liquid.”

If multiple liquids are introduced into one receiving chamber, they are by preference not miscible. In the case of a combination of two inventive liquids, the latter preferably have different properties such as color, turbidity, viscosity, or the presence of suspended constituents in the liquid.

Water-soluble or water-dispersible package having one receiving chamber:

Receiving chamber 1

Inventive liquid and liquid
Inventive liquid and powder
Inventive liquid and granules
Inventive liquid and compactate
Inventive liquid and extrudate
Inventive liquid and molded elements
Inventive liquid and dimensionally stable gel

Water-soluble or water-dispersible package having two receiving chambers:

| Receiving chamber 1 | Receiving chamber 2 |
|---|---|
| Inventive liquid | liquid |
| Inventive liquid | powder |
| Inventive liquid | granules |
| Inventive liquid | compactate |
| Inventive liquid | extrudate |
| Inventive liquid | molded elements |
| Inventive liquid | dimensionally stable gel |
| Inventive liquid | Inventive liquid 2 |
| Inventive liquid and powder | liquid |
| Inventive liquid and powder | powder |
| Inventive liquid and powder | granules |
| Inventive liquid and powder | compactate |
| Inventive liquid and powder | extrudate |
| Inventive liquid and powder | molded elements |
| Inventive liquid and powder | dimensionally stable gel |
| Inventive liquid and powder | Inventive liquid 2 |
| Inventive liquid and granules | liquid |
| Inventive liquid and granules | powder |
| Inventive liquid and granules | granules |
| Inventive liquid and granules | compactate |
| Inventive liquid and granules | extrudate |
| Inventive liquid and granules | molded elements |
| Inventive liquid and granules | dimensionally stable gel |
| Inventive liquid and granules | Inventive liquid 2 |
| Inventive liquid and compactate | liquid |
| Inventive liquid and compactate | powder |
| Inventive liquid and compactate | granules |
| Inventive liquid and compactate | compactate |
| Inventive liquid and compactate | extrudate |
| Inventive liquid and compactate | molded elements |
| Inventive liquid and compactate | dimensionally stable gel |
| Inventive liquid and compactate | Inventive liquid 2 |
| Inventive liquid and extrudate | liquid |
| Inventive liquid and extrudate | powder |
| Inventive liquid and extrudate | granules |
| Inventive liquid and extrudate | compactate |
| Inventive liquid and extrudate | extrudate |
| Inventive liquid and extrudate | molded elements |
| Inventive liquid and extrudate | dimensionally stable gel |
| Inventive liquid and extrudate | Inventive liquid 2 |
| Inventive liquid and molded elements | liquid |
| Inventive liquid and molded elements | powder |
| Inventive liquid and molded elements | granules |
| Inventive liquid and molded elements | compactate |
| Inventive liquid and molded elements | extrudate |
| Inventive liquid and molded elements | molded elements |
| Inventive liquid and molded elements | dimensionally stable gel |
| Inventive liquid and molded elements | Inventive liquid 2 |

Water-soluble or water-dispersible package having three receiving chambers:

| Receiving | | |
|---|---|---|
| chamber 1 | Receiving chamber 2 | Receiving chamber 3 |
| Inventive liquid | liquid | liquid |
| Inventive liquid | powder | liquid |
| Inventive liquid | granules | liquid |
| Inventive liquid | compactate | liquid |
| Inventive liquid | extrudate | liquid |
| Inventive liquid | molded elements | liquid |
| Inventive liquid | dimensionally stable gel | liquid |
| Inventive liquid | liquid | powder |
| Inventive liquid | powder | powder |
| Inventive liquid | granules | powder |
| Inventive liquid | compactate | powder |
| Inventive liquid | extrudate | powder |
| Inventive liquid | molded elements | powder |
| Inventive liquid | dimensionally stable gel | powder |
| Inventive liquid | liquid | granules |
| Inventive liquid | powder | granules |
| Inventive liquid | granules | granules |
| Inventive liquid | compactate | granules |
| Inventive liquid | extrudate | granules |
| Inventive liquid | molded elements | granules |
| Inventive liquid | dimensionally stable gel | granules |
| Inventive liquid | liquid | compactate |
| Inventive liquid | powder | compactate |
| Inventive liquid | granules | compactate |
| Inventive liquid | compactate | compactate |
| Inventive liquid | extrudate | compactate |
| Inventive liquid | molded elements | compactate |
| Inventive liquid | dimensionally stable gel | compactate |
| Inventive liquid | liquid | extrudate |
| Inventive liquid | powder | extrudate |
| Inventive liquid | granules | extrudate |
| Inventive liquid | compactate | extrudate |
| Inventive liquid | extrudate | extrudate |
| Inventive liquid | molded elements | extrudate |
| Inventive liquid | dimensionally stable gel | extrudate |
| Inventive liquid | liquid | molded elements |
| Inventive liquid | powder | molded elements |
| Inventive liquid | granules | molded elements |
| Inventive liquid | compactate | molded elements |
| Inventive liquid | extrudate | molded elements |
| Inventive liquid | molded elements | molded elements |
| Inventive liquid | dimensionally stable gel | molded elements |
| Inventive liquid | liquid | dimensionally stable gel |
| Inventive liquid | powder | dimensionally stable gel |
| Inventive liquid | granules | dimensionally stable gel |
| Inventive liquid | compactate | dimensionally stable gel |
| Inventive liquid | extrudate | dimensionally stable gel |
| Inventive liquid | molded elements | dimensionally stable gel |
| Inventive liquid | dimensionally stable gel | dimensionally stable gel |
| Inventive liquid | liquid | Inventive liquid 2 |
| Inventive liquid | powder | Inventive liquid 2 |
| Inventive liquid | granules | Inventive liquid 2 |
| Inventive liquid | compactate | Inventive liquid 2 |
| Inventive liquid | extrudate | Inventive liquid 2 |
| Inventive liquid | molded elements | Inventive liquid 2 |
| Inventive liquid | dimensionally stable gel | Inventive liquid 2 |

A further subject of the present application is the use of an agent according to the present invention as a cleaning agent in an automatic dishwasher.

As described previously, the liquid cleaning-agent compositions according to the present invention can be presented alone or in combination with further liquid or solid washing or cleaning agents (e.g. powders, extrudates, compactates). Both the liquid cleaning-agent compositions according to the present invention and the further liquid or solid cleaning agents optionally presented with said compositions to yield a combination product can contain, in addition to the active substances described above, further active substances from the group of the builders, surfactants, polymers, bleaching agents, bleach activators, enzymes, glass corrosion inhibitors, corrosion inhibitors, disintegration adjuvants, fragrances, and perfume carriers. These and further active substances contained in the cleaning-agent compositions according to the present invention or combination products are described below.

Builders

The builders include, in particular, the zeolites, silicates, carbonates, organic cobuilders and even (where no environmental prejudices against their use exist) the phosphates.

The finely crystalline synthetic zeolite containing bound water that is used is preferably zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferred for use in the context of the present invention is, for example, a co-crystal of zeolite X and zeolite A (approx. 80 wt % zeolite X) that is marketed by CONDEA Augusta S.p.A. under the trade name VEGOBOND AX® and can be described by the formula
nNa₂O.(1−n)K₂O.Al₂O₃.(2−2.5)SiO₂.(3.5−5.5)H₂O.
The zeolite can be used both as a builder in a granular compound and as a kind of “dusting” of a granular mixture, preferably a mixture that is to be compressed, both approaches to incorporating the zeolite into the premixture usually being used. Suitable zeolites exhibit an average particle size of less than 10 μm (volume distribution; measurement method: Coulter Counter), and contain by preference 18 to 22 wt %, in particular 20 to 22 wt %, bound water.

Suitable crystalline, sheet-form sodium silicates possess the general formula NaMSiₓO₂ₓ₊₁.H₂O, where M denotes sodium or hydrogen, x a number from 1.9 to 4, and y is a number from 0 to 20, and preferred values for x are 2, 3, or 4. Preferred crystalline sheet silicates of the formula indicated above are those in which M denotes sodium and x assumes the value 2 or 3. Both β- and δ-sodium disilicates Na₂Si₂O₅.yH₂O are particularly preferred.

Crystalline sheet-form sodium silicates of the general formula NaMSiₓO₂ₓ₊₁.y H₂O, where M denotes sodium or hydrogen, x is a number from 1.9 to 22, preferably from 1.9 to 4, and y denotes a number from 0 to 33, are used with particular advantage, in particular as a constituent of automatic dishwashing agents. The crystalline sheet-form silicates of the formula NaMSiₓO₂ₓ₊₁.H₂O are marketed, for example, by Clariant GmbH (Germany) under the trade name Na-SKS. Examples of these silicates are Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O), or Na-SKS-4 (Na₂Si₄O₉.xH₂O, makatite).

Particularly suitable for purposes of the present invention are crystalline sheet-form silicates of the formula NaMSiₓO₂₊₁.yH₂O in which x denotes 2. Especially suitable, of these, are Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅), and Na-SKS-13 (NaHSi₂O₅), but in particular Na-SKS-6 (δ-Na₂Si₂O₅). When the silicates are used as a constituent of automatic dishwashing agents, said agents then preferably contain a weight proportion of the crystalline sheet-form silicate of the formula NaMSiₓO₂ₓ₊₁.yH₂O from 0.1 to 20 wt %, from 0.2 to 15 wt %, and in particular from 0.4 to 10 wt %, based in each case on the total weight of said agents. It is, in particular, particularly preferred when such automatic dishwashing agents have a total silicate content below 7 wt %, by preference below 6 wt %, preferably below 5 wt %, particularly preferably below 4 wt %, very particularly preferably below 3 wt %, and in particular below 2.5 wt %, silicate of the general formula NaMSiₓO₂₊₁.yH₂O constituting by preference at least 70 wt %, preferably at least 80 wt %, and in particular at least 90 wt % of the aforesaid silicate, based on the total weight of the contained silicate.

Also usable are amorphous sodium silicates having a Na₂O: SiO₂ modulus of 1:2 to 1:3.3, by preference 1:2 to 1:2.8, and in particular 1:2 to 1:2.6, which are dissolution-delayed and exhibit secondary washing properties. A dissolution delay as compared with conventional amorphous sodium silicates can have been brought about in various ways, for example by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but at most one or more maxima in the scattered X radiation that have a width of several degree units of the diffraction angle. Particularly good builder properties can, however, very easily be obtained even if the silicate particles yield blurred or even sharp diffraction maxima in electron beam diffraction experiments. This may be interpreted to mean that the products have microcrystalline regions 10 to several hundred nm in size, values of up to a maximum of 50 nm, and in particular a maximum of 20 nm, being preferred. So-called X-amorphous silicates of this kind likewise exhibit a dissolution delay as compared with conventional water glasses. Densified/compacted amorphous silicates, compounded amorphous silicates, and overdried X-amorphous silicates are particularly preferred.

It is preferred in the context of the present invention that this/these silicate(s), by preference alkali silicates, particularly preferably crystalline or amorphous alkali disilicates, be contained in washing or cleaning agents in quantities from 10 to 60 wt %, by preference from 15 to 50 wt %, and in particular from 20 to 40 wt %, based in each case on the weight of the washing or cleaning agent.

The use of the generally known phosphates as builder substances is of course also possible according to the present invention, provided such use in washing agents should not be avoided for environmental reasons. This applies in particular to the use of agents according to the present invention or manufactured using methods according to the present invention, which use is particularly preferred in the context of the present application. Among the plurality of commercially available phosphates, the alkali-metal phosphates, with particular preference for pentasodium or pentapotassium triphosphate (sodium or potassium tripolyphosphate), have the greatest significance in the washing and cleaning agent industry.

“Alkali-metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance.

Suitable phosphates are, for example, sodium dihydrogenphosphate, NaH₂PO₄, in the form of the dihydrate (density 1.91 gcm⁻³, melting point 60°) or the monohydrate (density 2.04 gcm⁻³), disodium hydrogenphosphate (secondary sodium phosphate), Na₂HPO₄, which exists anyhdrously or with 2 mol (density 2.066 gcm⁻³, water lost at 950), 7 mol (density 1.68 gcm⁻³, melting point 48° with loss of 5H₂O), and 12 mol of water (density 1.52 gcm⁻³, melting point 35° with loss of 5H₂O), but in particular trisodium phosphate (tertiary sodium phosphate), Na₃PO₄, which can be used as the dodecahydrate, the decahydrate (corresponding to 19-20% P₂O₅), and in anhydrous form (corresponding to 39-40% P₂O₅). A further preferred phosphate is tripotassium phosphate (tertiary or tribasic potassium phosphate), K₃PO₄. Also preferred are tetrasodium diphosphate (sodium pyrophosphate), Na₄P₂O₇, which exists in anhydrous form (density 2.534 gcm⁻³, melting point 988°, also indicated as 880°) and as the decahydrate (density 1.815-1.836 gcm⁻³, melting point 94° with loss of water), as well as the corresponding potassium salt potassium diphosphate (potassium pyrophosphate), K₄P₂O₇.

The technically important pentasodium triphosphate Na₅P₃O₁₀ (sodium tripolyphosphate) is a colorless, water-soluble, non-hygroscopic salt, crystallizing anhydrously or with 6H₂O, of the general formula NaO—[P(O)(ONa)—O]ₙ—Na, where n=3. The corresponding potassium salt, pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the washing- and cleaning-agent industry. Sodium potassium tripolyphosphates also exist and are likewise usable in the context of the present invention. They are produced, for example, when sodium trimetaphosphate is hydrolyzed with KOH:
(NaPO₃)₃+2 KOH→Na₃K₂P₃O₁₀+H₂O
These are usable according to the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable according to the present invention.

When phosphates are used in the context of the present application as substances having washing or cleaning activity in washing or cleaning agents, preferred agents then contain said phosphate(s), by preference alkali-metal phosphate(s), particularly preferably pentasodium or pentapotassium triphosphate (sodium or potassium tripolyphosphate), in quantities from 5 to 80 wt %, by preference from 15 to 75 wt %, and in particular from 20 to 70 wt %, based in each case on the weight of the washing or cleaning agent.

It is preferred to use, in particular, potassium tripolyphosphate and sodium tripolyphosphate at a weight ratio of more than 1:1, by preference more than 2:1, preferably more than 5:1, particularly preferably more than 10:1, and in particular more than 20:1. It is particularly preferred to use exclusively potassium tripolyphosphate with no admixtures of other phosphates.

Additional builders are the alkali carriers. Alkali carriers are considered to be, for example, alkali-metal hydroxides, alkali-metal carbonates, alkali-metal hydrogencarbonates, alkali-metal sesquicarbonates, the aforesaid alkali silicates, alkali metasilicates, and mixtures of the aforesaid substances, the alkali carbonates, in particular sodium carbonate, sodium hydrogencarbonate, or sodium sesquicarbonate, being used in preferred fashion for purposes of this invention. A builder system containing a mixture of tripolyphosphate and sodium carbonate is particularly preferred. Likewise particularly preferred is a builder system containing a mixture of tripolyphosphate and sodium carbonate and sodium disilicate. Because of their low chemical compatibility with the other ingredients of washing or cleaning agents as compared with other builder substances, the alkali-metal hydroxides are preferably used only in small quantities, by preference in quantities below 10 wt %, preferably below 6 wt %, particularly preferably below 4 wt %, and in particular below 2 wt %, based in each case on the total weight of the washing or cleaning agent. Agents that contain, based on their total weight, less than 0.5 wt % and in particular no alkali-metal hydroxides are particularly preferred.

The use of carbonate(s) and/or hydrogencarbonate(s), by preference alkali carbonate(s), particularly preferably sodium carbonate, is particularly preferred, in quantities from 2 to 50 wt %, by preference from 5 to 40 wt %, and in particular from 7.5 to 30 wt %, based in each case on the weight of the washing or cleaning agent. Agents that contain, based on the weight of the washing or cleaning agent, less than 20 wt %, by preference less than 17 wt %, preferably less than 13 wt %, and in particular less than 9 wt % carbonate(s) and/or hydrogencarbonate(s), by preference alkali carbonate(s), particularly preferably sodium carbonate, are particularly preferred.

Polycarboxylates/polycarboxylic acids, polymeric polycarboxylates, aspartic acid, polyacetals, dextrins, further organic co-builders (see below), and phosphonates may be mentioned in particular as organic cobuilders. These substance classes are described below.

Usable organic builder substances are, for example, the polycarboxylic acids usable in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, sugar acids, and mixtures thereof.

The acids per se can also be used. The acids typically also possess, in addition to their builder effect, the property of an acidifying component, and thus serve also to establish a lower and milder pH for washing or cleaning agents. Worthy of mention in this context are, in particular, citric acid, succinic acid, glutaric acid, adipic acid, gluconic acid, and any mixtures thereof.

Further suitable as builders are polymeric polycarboxylates; these are, for example, the alkali-metal salts of polyacrylic acid or polymethacrylic acid, for example those having a relative molecular weight from 500 to 70,000 g/mol.

The molar weights indicated for the polymeric polycarboxylates are, for purposes of this document, weight-averaged molar weights M_{w} of the respective acid form that were determined in principle by means of gel permeation chromatography (GPC), a UV detector having been used. The measurement was performed against an external polyacrylic acid standard that, because of its structural affinity with the polymers being investigated, yields realistic molecular weight values. These indications deviate considerably from the molecular weight indications in which polystyrenesulfonic acids are used as a standard. The molar weights measured against polystyrenesulfonic acids are usually much higher than the molar weights indicated in this document.

Suitable polymers are, in particular, polyacrylates that preferably have a molecular weight from 2000 to 20,000 g/mol. Because of their superior solubility, of this group the short-chain polyacrylates that have molar weights from 2000 to 10,000 g/ml, and particularly preferably from 3000 to 5000 g/mol, may in turn be preferred.

Copolymeric polycarboxylates, in particular those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, by preference 20,000 to 50,000 g/mol, and in particular 30,000 to 40,000 g/mol.

The (co)polymeric polycarboxylates can be used as either a powder or an aqueous solution. The (co)polymeric polycarboxylate content of washing or cleaning agents is by preference 0.5 to 20 wt %, in particular 3 to 10 wt %.

To improve water solubility, the polymers can also contain allylsulfonic acids, for example allyloxybenzenesulfonic acid and methallylsulfonic acid, as monomers.

Also particularly preferred are biodegradable polymers made up of more than two different monomer units, for example those that contain as monomers salts of acrylic acid and of maleic acid as well as vinyl alcohol or vinyl alcohol derivatives; or that contain as monomers salts of acrylic acid and of 2-alkylallylsulfonic acid, as well as sugar derivatives

Further preferred copolymers are those that preferably comprise acrolein and acrylic acid/acrylic acid salts, or acrolein and vinyl acetate, as monomers.

Polymeric aminodicarboxylic acids, their salts, or their precursor substances may likewise be mentioned as additional preferred builder substances. Polyaspartic acids and their salts are particularly preferred.

Further suitable builder substances are polyacetals, which can be obtained by reacting dialdehydes with polyolcarboxylic acids having 5 to 7 carbon atoms and at least three hydroxyl groups. Preferred polyacetals are obtained from dialdehydes such as glyoxal, glutaraldehyde, terephthalaldehyde and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be performed using ordinary, for example acid- or enzyme-catalyzed, methods. The hydrolysis products preferably have average molar weights in the range from 400 to 500,000 g/mol. A polysaccharide having a dextrose equivalent (DE) in the range from 0.5 to 40, in particular from 2 to 30, is preferred, DE being a common indicator of the reducing power of a polysaccharide as compared with dextrose, which possesses a DE of 100. Both maltodextrins having a DE of between 3 and 20 and dry glucose syrups having a DE of between 20 and 37, and so-called yellow dextrins and white dextrins having higher molar weights in the range from 2000 to 30,000 g/mol, are usable.

Relevant oxidized derivatives of such dextrins are their reaction products with oxidizing agents that are capable of oxidizing at least one alcohol function of the saccharide ring to the carboxylic acid function.

Oxydisuccinates and other derivatives of disuccinates, preferably ethylenediamine disuccinate, are additional suitable cobuilders. Ethylenediamine N,N′-disuccinate (EDDS) is used, preferably in the form of its sodium or magnesium salts. Also preferred in this context are glycerol disuccinates and glycerol trisuccinates. Suitable utilization quantities in zeolite- and/or silicate-containing formulations are 3 to 15 wt %.

Further usable organic builders are, for example, acetylated hydroxycarboxylic acids and their salts, which may optionally also be present in lactone form and which contain at least 4 carbon atoms and at least one hydroxy group, as well as a maximum of two acid groups.

All compounds that are capable of forming complexes with alkaline-earth ions can furthermore be used as builders.

Surfactants

The group of the surfactants encompasses the nonionic, anionic, cationic and amphoteric surfactants.

All nonionic surfactants known to one skilled in the art can be used as nonionic surfactants. Low-foaming nonionic surfactants are used as preferred surfactants. Particularly preferably, washing or cleaning agents, in particular cleaning agents for automatic dishwashing, contain nonionic surfactants, in particular nonionic surfactants from the group of the alkoxylated alcohols. The nonionic surfactants used are preferably alkoxylated, advantageously ethoxylated, in particular primary alcohols having by preference 8 to 18 C atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 C atoms, e.g. from coconut, palm, tallow, or oleyl alcohol, and an average of 2 to 8 EO per mol of alcohol. The preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can correspond to an integral or fractional number for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

Also usable as further nonionic surfactants are alkyl glycosides of the general formula RO(G)ₓ, in which R denotes a primary straight-chain or methyl-branched (in particular methyl-branched in the 2-position) aliphatic radical having 8 to 22, by preference 12 to 18 C atoms; and G is the symbol denoting a glycose unit having 5 or 6 C atoms, preferably glucose. The degree of oligomerization x, which indicates the distribution of monoglycosides and oligoglycosides, is any number between 1 and 10; by preference, x is between 1.2 and 1.4.

A further class of nonionic surfactants used in preferred fashion, which are used either as the only nonionic surfactant or in combination with other nonionic surfactants, is alkoxylated, preferably ethoxylated or ethoxylated and propoxylated, fatty acid alkyl esters, preferably having 1 to 4 carbon atoms in the alkyl chain.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable. The quantity of these nonionic surfactants is preferably no more than that of the ethoxylated fatty alcohols, in particular no more than half thereof.

Further suitable surfactants are polyhydroxy fatty acid amides of the following formula: 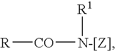
in which R denotes an aliphatic acyl radical having 6 to 22 carbon atoms; R¹ denotes hydrogen, an alkyl or hydroxyalkyl radical having 1 to 4 carbon atoms; and [Z] denotes a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of the following formula: 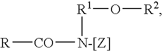
in which R denotes a linear or branched alkyl or alkenyl radical having 7 to 12 carbon atoms; R¹ denotes a linear, branched, or cyclic alkyl radical or an aryl radical having 2 to 8 carbon atoms; and R² denotes a linear, branched, or cyclic alkyl radical or an aryl radical or an oxyalkyl radical having 1 to 8 carbon atoms, C₁₋₄ alkyl or phenyl radicals being preferred; and [Z] denotes a linear polyhydroxyalkyl radical whose alkyl chain is substituted with at least two hydroxyl groups, or alkoxylated, preferably ethoxylated or propoxylated, derivatives of that radical.

[Z] is preferably obtained by reductive amination of a sugar, for example glucose, fructose, maltose, lactose, galactose, mannose, or xylose. The N-alkoxy- or N-aryloxy-substituted compounds can be converted into the desired polyhydroxy fatty acid amides by reaction with fatty acid methyl esters in the presence of an alkoxide as catalyst.

It is furthermore particularly preferred to use surfactants that contain one or more tallow fatty alcohols having 20 to 30 EO in combination with a silicone defoamer.

Nonionic surfactants from the group of the alkoxylated alcohols, particularly preferably from the group of the mixed alkoxylated alcohols, and in particular from the group of the EO-AO-EO nonionic surfactants, are likewise used with particular preference.

Nonionic surfactants that have a melting point above room temperature are particularly preferred. Nonionic surfactant(s) having a melting point above 20° C., by preference above 25° C., particularly preferably between 25 and 60° C., and in particular between 26.6 und 43.3° C., is/are particularly preferred.

Suitable nonionic surfactants that exhibit melting or softening points in the aforesaid temperature range are, for example, low-foaming nonionic surfactants that can be solid or highly viscous at room temperature. When nonionic surfactants that are highly viscous at room temperature are used, it is preferred for them to exhibit a viscosity greater than 20 Pa·s, by preference greater than 35 Pa·s, and in particular greater than 40 Pa·s. Nonionic surfactants that possess a waxy consistency at room temperature are also preferred.

Nonionic surfactants that are solid at room temperature and are preferred for use derive from the groups of the alkoxylated nonionic surfactants, in particular the ethoxylated primary alcohols, and mixtures of these surfactants with structurally more complex surfactants such as polyoxypropylene/polyoxyethylene/polyoxypropylene (PO/EO/PO) surfactants. Such PO/EO/PO nonionic surfactants are moreover characterized by good foam control.

In a preferred embodiment of the present invention, the nonionic surfactant having a melting point above room temperature is an ethoxylated nonionic surfactant that has resulted from the reaction of a monohydroxyalkanol or alkylphenol having 6 to 20 C atoms with preferably at least 12 mol, particularly preferably at least 15 mol, in particular at least 20 mol, of ethylene oxide per mol of alcohol or alkylphenol.

A nonionic surfactant that is solid at room temperature and is particularly preferred for use is obtained from a straight-chain fatty alcohol having 16 to 20 carbon atoms (C₁₆₋₂₀ alcohol), preferably a C₁₋₈ alcohol, and at least 12 mol, preferably at least 15 mol, and in particular at least 20 mol of ethylene oxide. Of these, the so-called “narrow range ethoxylates” (see above) are particularly preferred.

Ethoxylated nonionic surfactants that were obtained from C₆₋₂₀ monohydroxyalkanols or C₆₋₂₀ alkylphenols or C₁₆₋₂₀ fatty alcohols and more than 12 mol, preferably more than 15 mol, and in particular more than 20 mol ethylene oxide per mol of alcohol, are therefore used with particular preference.

The nonionic surfactant that is solid at room temperature preferably additionally possesses propylene oxide units in the molecule. Such PO units preferably constitute up to 25 wt %, particularly preferably up to 20 wt %, and in particular up to 15 wt % of the total molar weight of the nonionic surfactant. Particularly preferred nonionic surfactants are ethoxylated monohydroxyalkanols or alkylphenols that additionally comprise polyoxyethylene-polyoxypropylene block copolymer units. The alcohol or alkylphenol portion of such nonionic surfactant molecules preferably constitutes more than 30 wt %, particularly preferably more than 50 wt %, and in particular more than 70 wt % of the total molar weight of such nonionic surfactants. Preferred agents are characterized in that they contain ethoxylated and propoxylated nonionic surfactants in which the propylene oxide units in the molecule represent up to 25 wt %, preferably up to 20 wt %, and in particular up to 15 wt % of the total molar weight of the nonionic surfactant.

Additional nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene having 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Nonionic surfactants that can be used with particular preference are obtainable, for example, from Olin Chemicals under the name Poly Tergent® SLF-18.

Surfactants of the formula
R¹O[CH₂CH(CH₃)O]ₓ[CH₂CH₂O]_{y}CH₂CH(OH)R²
in which R¹ designates a linear or branched aliphatic hydrocarbon radical having 4 to 18 carbon atoms, or mixtures thereof; R² a linear or branched hydrocarbon radical having 2 to 26 carbon atoms, or mixtures thereof: and x denotes values between 0.5 and 1.5 and y denotes a value of at least 15, are additional particularly preferred nonionic surfactants.

Additional nonionic surfactants that are usable in preferred fashion are the end-capped poly(oxyalkylated) nonionic surfactants of the following formula:
R¹O[CH₂CH(R³)O]ₓ[CH₂]ₖCH(OH)[CH₂]ⱼOR²,
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and k and j denote values between 1 and 12, by preference between 1 and 5. If the value of x ≧2, each R³ in the formula R¹O[CH₂CH(R³)O]ₓ[CH₂]ₖCH(OH)[CH₂]ⱼOR² can be different. R¹ and R² are by preference linear or branched, saturated or unsaturated, aliphatic or aromatic hydrocarbon radicals having 6 to 22 carbon atoms, radicals having 8 to 18 C atoms being particularly preferred. For the R³ radical, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit in the square brackets can thereby be varied. If, for example, x denotes 3, the R³ radical can be selected so as to form ethylene oxide (R³═H) or propylene oxide (R³═CH₃) units that can be joined onto one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected as an example here, and can certainly be larger; the range of variation increases with rising values of x, and includes e.g. a large number of (EO) groups combined with a small number of (PO) groups, or vice versa.

Particularly preferred end-capped poly(oxyalkylated) alcohols of the above formula have values of k=1 and j=1, so that the formula above is simplified to
R¹O[CH₂CH(R³)O]ₓCH₂CH(OH)CH₂OR².
In the latter formula, R¹, R², and R³ are as defined above, and x denotes numbers from 1 to 30, by preference from 1 to 20, and in particular from 6 to 18. Surfactants in which the R¹ and R² radicals have 9 to 14 C atoms, R³ denotes H, and x assumes values from 6 to 15, are particularly preferred.

Summarizing what has just been stated, end-capped poly(oxyalkylated) nonionic surfactants of the formula
R¹O[CH₂CH(R³)O]ₓ[CH₂]ₖCH(OH)[CH₂]ⱼOR²
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30, and k and j denote values between 1 and 12, preferably between 1 and 5, are preferred, surfactants of the
R¹O[CH₂CH(R³)O]ₓCH₂CH(OH)CH₂OR²
type, in which x denotes numbers from 1 to 30, preferably from 1 to 20, and in particular from 6 to 18, being particularly preferred.

Low-foaming nonionic surfactants that comprise alternating ethylene-oxide and alkylene-oxide units have proven to be particularly preferred nonionic surfactants in the context of the present invention. Among these in turn, surfactants having EO-AO-EO-AO blocks are preferred, one to ten EO or AO groups being bound to one another in each case before being followed by a block of the respectively other groups. Preferred here are nonionic surfactants of the general formula 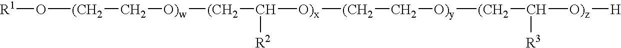
in which R¹ denotes a straight-chain or branched, saturated, or mono- or polyunsaturated C₆₋₂₄ alkyl or alkenyl radical; each R² and R³ group, mutually independently, is selected from —CH₃, —CH₂CH₃, —CH₂CH₂—CH₃, CH(CH₃)₂; and the indices w, x, y, and z denote, mutually independently, integers from 1 to 6.

The preferred nonionic surfactants of the above formula can be produced, using known methods, from the corresponding R¹—OH alcohols and ethylene oxide or alkylene oxide. The R¹ radical in the above formula VII can vary depending on the derivation of the alcohol. When natural sources are used, the R¹ radical has an even number of carbon atoms and is generally unbranched, the linear radicals from alcohols of natural origin having 12 to 18 carbon atoms, e.g. from coconut, palm, tallow, or oleyl alcohol, being preferred. Alcohols accessible from synthetic sources are, for example, the Guerbet alcohols or radicals methyl-branched in the 2-position or mixed linear and methyl-branched radicals, such as those usually present in oxo alcohol radicals. Regardless of the nature of the alcohol used for production of the nonionic surfactants contained according to the present invention in the agents, nonionic surfactants in which R¹ in the formula above denotes an alkyl radical having 6 to 24, preferably 8 to 20, particularly preferably 9 to 15, and in particular 9 to 11 carbon atoms, are preferred.

In addition to propylene oxide, butylene oxide in particular is a possibility as an alkylene oxide unit that is contained, alternatingly with the ethylene oxide unit, in the preferred nonionic surfactants. Further alkylene oxides, in which R² and R³, mutually independently, are selected from —CH₂CH₂—CH₃ or CH(CH₃)₂, are, however also suitable. It is preferred to use nonionic surfactants of the above formula in which R² and R³ denote a —CH₃ radical; w and x, mutually independently, denote values of 3 or 4; and y and z, mutually independently, denote values of 1 or 2.

In summary, nonionic surfactants that comprise a C₉₋₁₅ alkyl radical having 1 to 4 ethylene oxide units, followed by 1 to 4 propylene oxide units, followed by 1 to 4 ethylene oxide units, followed by 1 to 4 propylene oxide units, are particularly preferred. These surfactants exhibit the necessary low viscosity in aqueous solution, and are usable with particular preference according to the present invention.

Additional nonionic surfactants that are usable in preferred fashion are the end-capped poly(oxyalkylated) nonionic surfactants of the formula
R¹O[CH₂CH(R³)O]ₓR²,
in which R¹ denotes linear or branched, saturated or unsaturated, aliphatic or aromatic hydrocarbon radicals having 1 to 30 carbon atoms; R² denotes linear or branched, saturated or unsaturated, aliphatic or aromatic hydrocarbon radicals having 1 to 30 carbon atoms, which by preference comprise between 1 and 5 hydroxy groups and by preference are further functionalized with an ether group; R³ denotes H or a methyl, ethyl, n-propyl, isopropyl, n-butyl, 2-butyl, or 2-methyl-2-butyl radical; and x denotes values between 1 and 40.

In a particularly preferred embodiment of the present application, R³ in the above general formula denotes H. From the group of the resulting end-capped poly(oxyalkylated) nonionic surfactants of the formula
R¹O[CH₂CH₂O]ₓR²,
those nonionic surfactants in which R¹ denotes linear or branched, saturated or unsaturated, aliphatic or aromatic hydrocarbon radicals having 1 to 30 carbon atoms, preferably having 4 to 20 carbon atoms; R² denotes linear or branched, saturated or unsaturated, aliphatic or aromatic hydrocarbon radicals having 1 to 30 carbon atoms, which preferably comprise between 1 and 5 hydroxy groups; and x denotes values between 1 and 40, are particularly preferred.

Particularly preferred are those end-capped poly(oxyalkylated) nonionic surfactants that, in accordance with the formula
R¹O[CH₂CH₂O]ₓCH₂CH(OH)R²,
in addition to an R¹ radical that denotes linear or branched, saturated or unsaturated, aliphatic or aromatic hydrocarbon radicals having 1 to 30 carbon atoms, by preference having 4 to 20 carbon atoms, additionally comprise a linear or branched, saturated or unsaturated, aliphatic or aromatic hydrocarbon radical R² having 1 to 30 carbon atoms which is adjacent to a monohydroxylated intermediate group —CH₂CH(OH)—. In this formula, x denotes values between 1 and 90.

Particularly preferred are nonionic surfactants of the general formula
R¹O[CH₂CH₂O]ₓCH₂CH(OH)R²
that, in addition to an R¹ radical that denotes linear or branched, saturated or unsaturated, aliphatic or aromatic hydrocarbon radicals having 1 to 30 carbon atoms, preferably having 4 to 20 carbon atoms, additionally comprise a linear or branched, saturated or unsaturated, aliphatic or aromatic hydrocarbon radical R² having 1 to 30 carbon atoms, by preference 2 to 22 carbon atoms, which is adjacent to a monohydroxylated intermediate group —CH₂CH(OH)— and in which x denotes values between 40 and 80, by preference values between 40 and 60.

The corresponding end-capped poly(oxyalkylated) nonionic surfactants can be obtained, for example, by reacting an end-position epoxide of the formula R²CH(O)CH₂ with an ethoxylated alcohol of the formula R¹O[CH₂CH₂O]ₓ₋₁CH₂CH₂OH.

Also particularly preferred are those end-capped poly(oxyalkylated) nonionic surfactants of the formula
R¹O[CH₂CH₂O]ₓ[CH₂CH(CH₃)O]_{y}CH₂CH(OH)R²
in which R¹ and R², mutually independently, denote a linear or branched, saturated, or mono- or polyunsaturated hydrocarbon radical having 2 to 26 carbon atoms, R³ is selected, mutually independently, from —CH₃, —CH₂CH₃, —CH₂CH₂—CH₃, CH(CH₃)₂, but preferably denotes —CH₃, and x and y, mutually independently, denote values between 1 and 32, nonionic surfactants having values from 15 to 32 for x and from 0.5 to 1.5 for y being very particularly preferred.

Surfactants of the general formula 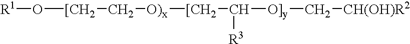
in which R¹ and R², mutually independently, denote a linear or branched, saturated, or mono- or polyunsaturated hydrocarbon radical having 2 to 26 carbon atoms, R³ is selected, mutually independently, from —CH₃, —CH₂CH₃, —CH₂CH₂—CH₃, CH(CH₃)₂, but preferably denotes —CH₃, and x and y, mutually independently, denote values between 1 and 32, are preferred according to the present invention, nonionic surfactants having values from 15 to 32 for x and from 0.5 to 1.5 for y being very particularly preferred.

The carbon chain lengths, degrees of ethoxylation, and degrees of alkoxylation indicated for the aforesaid nonionic surfactants represent statistical averages that may be an integer or a fractional number for a specific product. As a result of production methods, commercial products of the aforesaid formulas are usually made up not of an individual representative, but rather of mixtures, so that average values and, as a consequence, fractional numbers can result both for the carbon chain lengths and for the degrees of ethoxylation and degrees of alkoxylation.

The aforesaid nonionic surfactants can of course be used not only as individual substances, but also as surfactant mixtures made up of two, three, four, or more surfactants. “Surfactant mixtures” refers not to mixtures of nonionic surfactants that fall, in their totality, under one of the aforesaid general formulas, but instead to those mixtures containing two, three, four, or more nonionic surfactants that can be described by different ones of the aforesaid general formulas.

Anionic surfactants that can be used are, for example, those of the sulfonate and sulfate types. Possibilities as surfactants of the sulfonate type are, by preference, C₉₋₁₃ alkyl benzenesulfonates, olefinsulfonates, i.e. mixtures of alkene and hydroxyalkanesulfonates, and disulfonates, for example such as those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm kernel, or tallow fatty acids, are likewise suitable.

Further suitable anionic surfactants are sulfonated fatty acid glycerol esters. “Fatty acid glycerol esters” are understood as the mono-, di- and triesters, and mixtures thereof, that are obtained during the production by esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or behenic acid.

Preferred alk(en)yl sulfates are the alkali, and in particular sodium, salts of the sulfuric acid semi-esters of the C₁₂-C₁₈ fatty alcohols, for example from coconut fatty alcohol, tallow fatty alcohol, lauryl, myristyl, cetyl, or stearyl alcohol, or the C₁₀-C₂₀ oxo alcohols and those semi-esters of secondary alcohols of those chain lengths. Additionally preferred are alk(en)yl sulfates of the aforesaid chain length that contain a synthetic straight-chain alkyl radical produced on a petrochemical basis, which possess a breakdown behavior analogous to those appropriate compounds based on fat-chemistry raw materials. For purposes of washing technology, the C₁₂-C₁₆ alkyl sulfates and C₁₂-C₁₅ alkyl sulfates, as well as C₁₄-C₁₅ alkyl sulfates, are preferred. 2,3-alkyl sulfates that can be obtained, as commercial products of the Shell Oil Company, under the name DAN®, are also suitable anionic surfactants.

The sulfuric acid monoesters of straight-chain or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO, are also suitable. Because of their high foaming characteristics they are used in cleaning agents only in relatively small quantities, for example in quantities from 1 to 5 wt %.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and in particular ethoxylated fatty alcohols. Preferred sulfosuccinates contain C₈₋₁₈ fatty alcohol radicals or mixtures thereof. Particularly preferred sulfosuccinates contain a fatty alcohol radical that is derived from ethoxylated fatty alcohols which, considered per se, represent nonionic surfactants. Sulfosuccinates whose fatty alcohol radicals derive from ethoxylated fatty alcohols with a restricted homolog distribution are, in turn, particularly preferred. It is likewise also possible to use alk(en)ylsuccinic acid having by preference 8 to 18 carbon atoms in the alk(en)yl chain, or salts thereof.

Further appropriate anionic surfactants are, in particular, soaps. Saturated fatty acid soaps, such as the salts of lauric acid, myristic acid, palmitic acid, stearic acid, hydrogenated erucic acid, and behenic acid, are suitable, as are soap mixtures derived in particular from natural fatty acids, e.g. coconut, palm kernel, or tallow fatty acids.

The anionic surfactants, including the soaps, can be present in the form of their sodium, potassium, or ammonium salts, and as soluble salts of organic bases, such as mono-, di-, or triethanolamine. The anionic surfactants are preferably present in the form of their sodium or potassium salts, in particular in the form of the sodium salts.

When the anionic surfactants are a constituent of automatic dishwashing agents, their content is by preference less than 4 wt %, preferably less than 2 wt %, and very particularly preferably less than 1 wt %, based on the total weight of the agents. Automatic dishwashing agents that contain no anionic surfactants are particularly preferred.

Instead of the aforesaid surfactants or in combination with them, cationic and/or amphoteric surfactants can also be used.

Cationic active substances that can be used are, for example, cationic compounds of the following formulas: 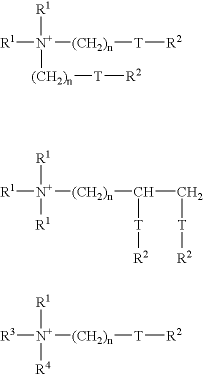
in which each R¹ group, mutually independently, is selected from C₁₋₆ alkyl, alkenyl, or hydroxyalkyl groups; each R² group, mutually independently, is selected from C₈₋₂₈ alkyl or alkenyl groups; R³═R¹ or (CH₂)ₙ-T-R²; R⁴═R¹ or R² or (CH₂)ₙ-T-R²; T=—CH₂—, —O—CO— or —CO—O—, and n is an integer from 0 to 5.

In automatic dishwashing agents, the concentration of cationic and/or amphoteric surfactants is by preference less than 6 wt %, preferably less than 4 wt %, very particularly preferably less than 2 wt %, and in particular less than 1 wt %. Automatic dishwashing agents that contain no cationic or amphoteric surfactants are particularly preferred.

Polymers

The group of the polymers includes, in particular, the polymers having washing or cleaning activity, for example the clear-rinsing polymers and/or polymers active as softeners. In addition to nonionic polymers, cationic, anionic, and amphoteric polymers are also usable in general in washing or cleaning agents.

“Cationic polymers” for purposes of the present invention are polymers that carry a positive charge in the polymer molecule. This can be implemented, for example, by way of (alkyl)ammonium groupings or other positively charged groups present in the polymer chain. Particularly preferred cationic polymers derive from the groups of the quaternized cellulose derivatives, the polysiloxanes having quaternary groups, the cationic guar derivatives, the polymeric dimethyldiallylammonium salts and their copolymers with esters and amides of acrylic acid and methacrylic acid, the copolymers of vinylpyrrolidone with quaternized derivatives of dialkylaminoacrylate and -methacrylate, the vinylpyrrolidone/methoimidazolinium chloride copolymers, the quaternized poly(vinylalcohols), or the polymers known by the INCI designations Polyquaternium 2, Polyquaternium 17, Polyquaternium 18, and Polyquaternium 27.

“Amphoteric polymers” for purposes of the present invention further comprise, in addition to a positively charged group in the polymer chain, negatively charged groups or monomer units. These groups can be, for example, carboxylic acids, sulfonic acids, or phosphonic acids.

Preferred washing or cleaning agents, in particular automatic dishwashing agents, are characterized in that they contain a polymer a) that comprises monomer units of the formula R¹R²C═CR³R⁴ in which each radical R¹, R², R³, R⁴ is selected, mutually independently, from hydrogen, a derivatized hydroxy group, C₁₋₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternized N atom or at least one amino group having a positive charge in the sub-range of the pH range from 2 to 11, or salts thereof, with the stipulation that at least one radical R¹, R², R³, R⁴ is a heteroatomic organic group having at least one positive charge without charged nitrogen, at least one quaternized N atom, or at least one amino group having a positive charge.
Cationic or amphoteric polymers that are particularly preferred in the context of the present invention contain as a monomer unit a compound of the general formula 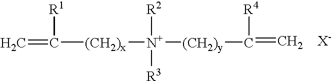
in which R¹ and R⁴, mutually independently, denote H or a linear or branched hydrocarbon radical having 1 to 6 carbon atoms; R² and R³, mutually independently, denote an alkyl, hydroxyalkyl, or aminoalkyl group in which the alkyl radical is linear or branched and comprises between 1 and 6 carbon atoms, this preferably being a methyl group; x and y, mutually independently, denote integers between 1 and 3. X⁻ represents a counterion, preferably a counterion from the group of chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate, or mixtures thereof.

Preferred radicals R¹ and R⁴ in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Very particularly preferred are polymers that comprise a cationic monomer unit of the above general formula in which R¹ and R⁴ denote H, R² and R³ denote methyl, and x and y are each 1. The corresponding monomer units of the formula 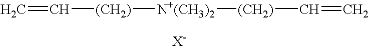
are also referred to, in the case in which X⁻=chloride, as DADMAC (diallyldimethylammonium chloride).

Further particularly preferred cationic or amphoteric polymers contain a monomer unit of the general formula 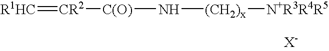
in which R¹, R², R³, R⁴ and R⁵, mutually independently, denote a linear or branched, saturated or unsaturated alkyl or hydroxyalkyl radical having 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x denotes a whole number between 1 and 6.

Very particularly preferred in the context of the present application are polymers that comprise a cationic monomer unit of the above general formula in which R¹ denotes H and R², R³, R⁴, and R⁵ denote methyl and x denotes 3. The corresponding monomer units of the formula 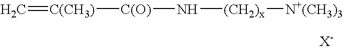
are also referred to, in the case where [symbol] =chloride, as MAPTAC (methyacrylamidopropyltrimethylammonium chloride).

Polymers that contain, as monomer units, diallyldimethylammonium salts and/or acrylamidopropyltrimethylammonium salts are preferred according to the present invention.

The aforementioned amphoteric polymers comprise not only cationic groups but also anionic groups or monomer units. Anionic monomer units of this kind derive, for example, from the group of the linear or branched, saturated or unsaturated carboxylates, the linear or branched, saturated or unsaturated phosphonates, the linear or branched, saturated or unsaturated sulfates, or the linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid, and their derivatives, the allylsulfonic acids such as, for example, allyloxybenzenesulfonic acid and methallylsulfonic acid, or the allylphosphonic acids.

Amphoteric polymers preferred for use derive from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkylmethacrylate/alkylaminoethylmethacrylate/alkylmethacrylate copolymers, and the copolymers of unsaturated carboxylic acids, cationically derivatized unsaturated carboxylic acids and, if applicable, further ionic or nonionogenic monomers.

Zwitterionic polymers preferred for use derive from the group of the acrylamidoalkyltrialkylammonium chloride/acrylic acid copolymers and their alkali and ammonium salts, the acrylamidoalkyltrialkylammonium chloride/methacrylic acid copolymers and their alkali and ammonium salts, and the methacroylethylbetaine/meth-acrylate copolymers.

Also preferred are amphoteric polymers that, in addition to one or more anionic monomers, encompass methacrylamidopropyltrimethylammonium chloride and dimethyl(diallyl)ammonium chloride as cationic monomers.

Particularly preferred amphoteric polymers derive from the group of the methacrylamidoalkyltrialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers, and the methacrylamidoalkyltrialkylammonium chloride/dimethyl(diallyl)ammonium chloride/alkyl(meth)acrylic acid copolymers, as well as their alkali and ammonium salts.

Particularly preferred are amphoteric polymers from the group of the methacrylamidopropyltrimethylammonium chloride/dimethyl(diallyl)ammonium chloride/acrylic acid copolymers, the methacrylamidopropyltrimethylammonium chloride/dimethyl(diallyl)ammonium chloride/acrylic acid copolymers, and the methacrylamidopropyltrimethylammonium chloride/dimethyl(diallyl)ammonium chloride/alkyl(meth)acrylic acid copolymers, as well as their alkali and ammonium salts.

In a particularly preferred embodiment of the present invention, the polymers are present in prepackaged form. Suitable for packaging of the polymers are, among others:
encapsulation of the polymers by means of water-soluble or water-dispersible coating agents, preferably by means of water-soluble or water-dispersible natural or synthetic polymers;
encapsulation of the polymers by means of water-insoluble, meltable coating agents, preferably by means of water-insoluble coating agents from the group of the waxes or paraffins having a melting point above 30° C.;
cogranulation of the polymers with inert carrier materials, by preference with carrier materials from the group of the substances having washing or cleaning activity, particularly preferably from the group of the builders (detergency builders) or cobuilders.

Washing or cleaning agents contain the aforesaid cationic and/or amphoteric polymers by preference in quantities between 0.01 and 10 wt %, based in each case on the total weight of the washing or cleaning agent. Preferred in the context of the present application, however, are those washing or cleaning agents in which the weight proportion of the cationic and/or amphoteric polymers is between 0.01 and 8 wt %, by preference between 0.01 and 6 wt %, preferably between 0.01 and 4 wt %, particularly preferably between 0.01 and 2 wt %, and in particular between 0.01 and 1 wt %, based in each case on the total weight of the automatic dishwashing agent.

Polymers effective as softeners are, for example, the sulfonic acid group-containing polymers, which are used with particular preference.

Particularly preferred for use as sulfonic acid group-containing polymers are copolymers of unsaturated carboxylic acids, sulfonic acid group-containing monomers, and if applicable further ionic or nonionogenic monomers.

Preferred as monomers in the context of the present invention are unsaturated carboxylic acids of the formula
R¹(R²)C═C(R³)COOH
in which R¹ to R³, mutually independently, denote —H —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms.

Among the unsaturated carboxylic acids that can be described by the above formula, acrylic acid (R¹═R²═R³═H), methacrylic acid (R¹═R²═H; R³═CH₃) and/or maleic acid (R¹═COOH; R²═R³═H) are particularly preferred.

Preferred in the context of the sulfonic acid group-containing monomers are those of the formula
R⁵(R⁶)C═C(R⁷)—X—SO₃H
in which R⁵ to R⁷, mutually independently, denote —H —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—.

Preferred among these monomers are those of the formulas
H₂C═CH—X—SO₃H
H₂C═C(CH₃)—X—SO₃H
HO₃S—X—(R⁶)C═C(R⁷)—X—SO₃H
in which R⁶ and R⁷, mutually independently, are selected from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and water-soluble salts of the aforesaid acids.

Ethylenically unsaturated compounds, in particular, are suitable as further ionic or nonionogenic monomers. The concentration of these further ionogenic or nonionogenic monomers in the polymers that are used is preferably less than 20 wt % based on the polymer. Polymers to be used in particularly preferred fashion comprise only monomers of the formula R¹(R²)C═C(R³)COOH and monomers of the formula R⁵(R⁶)C═C(R⁷)—X—SO₃H.

In summary, copolymers of

i) unsaturated carboxylic acids of the formula R¹ (R²)C═C(R³)COOH in which R¹ to R³, mutually independently, denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms,
ii) sulfonic acid group-containing monomers of the formula R⁵(R⁶)C═C(R⁷)—X—SO₃H
   in which R⁵ to R⁷, mutually independently, denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms; and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,
iii) if applicable, further ionic or nonionogenic monomers, are particularly preferred.

Particularly preferred copolymers are made up of
i) one or more unsaturated carboxylic acids from the group of acrylic acid, methacrylic acid, and/or maleic acid;
ii) one or more sulfonic acid group-containing monomers of the formulas
   H₂C═CH—X—SO₃H
   H₂C═C(CH₃)—X—SO₃H
   HO₃S—X—(R⁶)C═C(R⁷)—X—SO₃H
   in which R⁶ and R⁷, are selected, mutually independently, from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,
iii) if applicable, further ionic or nonionogenic monomers.

The copolymers can contain the monomers from groups i) and ii), and if applicable iii), in varying quantities, in which context all representatives of group i) can be combined with all representatives of group ii) and all representatives of group iii). Particularly preferred polymers exhibit certain structural units that are described below.

Preferred, for example, are copolymers that contain structural units of the formula
—[CH₂—CHCOOH]ₘ—[CH₂—CHC(O)—Y—SO₃H]ₚ—
in which m and p each denote a natural integer between 1 and 2000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, being preferred.

These polymers are produced by copolymerization of acrylic acid with a sulfonic acid group-containing acrylic acid derivative. When the sulfonic acid group-containing acrylic acid derivative is copolymerized with methacrylic acid, a different polymer is arrived at, the use of which is likewise preferred. The corresponding copolymers contain structural units of the formula
—[CH₂—C(CH₃)COOH]ₘ—[CH₂—CHC(O)—Y—SO₃H]ₚ—
in which m and p each denote a natural integer between 1 and 2000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—C₆H₄)—, —NH—C(CH₃)₂—, or —NH—CH(CH₂CH₃)—, being preferred.

Entirely analogously, acrylic acid and/or methacrylic acid can also be copolymerized with sulfonic acid group-containing methacrylic acid derivatives, thereby modifying the structural units in the molecule. Copolymers that contain structural units of the formula
—[CH₂—CHCOOH]ₘ—[CH₂—C(CH₃)C(O)—Y—SO₃H]ₚ—
in which m and p each denote a natural integer between 1 and 2000, and Y denotes a spacer group that is selected from substituted or unsubstituted aliphatic, aromatic, or substituted aromatic hydrocarbon radicals having 1 to 24 carbon atoms, spacer groups in which Y denotes —O(CH₂)ₙ— where n=0 to 4, —O—C₆H₄)—, —NH—C(CH₃)₂—, or —NH—CH(CH₂CH₃)—, being preferred, are therefore likewise preferred, as are copolymers that contain structural units of the formula
—[CH₂—C(CH₃)COOH]ₘ—[CH₂—C(CH₃)C(O)—Y—SO₃H]ₚ—
in which m and p each denote a natural integer between 1 and 2000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—C₆H₄)—, —NH—C(CH₃)₂—, or —NH—CH(CH₂CH₃)—, being preferred.

Instead of acrylic acid and/or methacrylic acid or as a supplement thereto, maleic acid can also be used as a particularly preferred monomer of group i). This results in copolymers preferred according to the present invention which contain structural units of the formula
—[HOOCCH—CHCOOH]ₘ—[CH₂—CHC(O)—Y—SO₃H]ₚ—
in which m and p each denote a natural integer between 1 and 2000, and Y denotes a spacer group that is selected from substituted or unsubstituted aliphatic or aromatic hydrocarbon radicals having 1 to 24 carbon atoms, spacer groups in which Y denotes —O—(CH₂)ₙ— where n ═0 to 4, —O—(C₆H₄)—, —NH—C(CH₃)₂—, or —NH—CH(CH₂CH₃)—, being preferred. Also preferred according to the present invention are copolymers which contain structural units of the formula
—[HOOCCH—CHCOOH]ₘ—[CH₂—C(CH₃)C(O)O—Y—SO₃H]ₚ—
in which m and p each denote a natural integer between 1 and 2000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—C₆H₄)—, —NH—C(CH₃)₂—, or —NH—CH(CH₂CH₃)—, being preferred.

In summary, preferred copolymers according to the present invention are those which contain structural units of the formulas
—[CH₂—CHCOOH]ₘ—[CH₂—CHC(O)—Y—SO₃H]ₚ—
—[CH₂—C(CH₃)COOH]ₘ—[CH₂—CHC(O)—Y—SO₃H]ₚ—
—[CH₂—CHCOOH]ₘ—[CH₂—C(CH₃)C(O)—Y—SO₃H]ₚ—
—[CH₂—C(CH₃)COOH]ₘ—[CH₂—C(CH₃)C(O)—Y—SO₃H]ₚ—
—[HOOCCH—CHCOOH]ₘ—[CH₂—CHC(O)—Y—SO₃H]ₚ—
—[HOOCCH—CHCOOH]ₘ—[CH₂—C(CH₃)C(O)O—Y—SO₃H]ₚ—
in which m and p each denote a natural integer between 1 and 2000, and Y denotes a spacer group that is selected from substituted or unsubstituted aliphatic, aromatic, or substituted aromatic hydrocarbon radicals having 1 to 24 carbon atoms, spacer groups in which Y denotes —O(CH₂)ₙ— where n=0 to 4, —O—C₆H₄)—, —NH—C(CH₃)₂—, or —NH—CH(CH₂CH₃)—, being preferred.

The sulfonic acid groups can be present in the polymers entirely or partially in neutralized form, i.e. the acid hydrogen atom of the sulfonic acid group can be exchanged, in some or all sulfonic acid groups, for metal ions, preferably alkali-metal ions, and in particular for sodium ions. The use of partially or entirely neutralized sulfonic acid group-containing copolymers is preferred according to the present invention.

The monomer distribution of the copolymers used in preferred fashion according to the present invention is, in copolymers that contain only monomers from groups i) and ii), by preference 5 to 95 wt % from each of i) and ii), particularly preferably 50 to 90 wt % monomer from group i) and 10 to 50 wt % monomer from group ii), based in each case on the polymer.

For terpolymers, those that contain 20 to 85 wt % monomer from group i), 10 to 60 wt % monomer from group ii), and 5 to 30 wt % monomer from group iii), are particularly preferred.

The molar weight of the sulfo-copolymers used in preferred fashion according to the present invention can be varied in order to adapt the properties of the polymers to the desired application. Preferred washing or cleaning agents are characterized in that the copolymers have molar weights from 2000 to 200,000 gmol⁻¹, preferably from 4000 to 25,000 gmol⁻¹, and in particular from 5000 to 15,000 gmol⁻¹.

Bleaching Agents

The bleaching agents are a substance having washing or cleaning activity that is used with particular advantage. Among the compounds yielding H₂O₂ in water that serve as bleaching agents, sodium percarbonate, sodium perborate tetrahydrate, and sodium perborate monohydrate are of particular importance. Other usable bleaching agents are, for example, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid.

Bleaching agents from the group of the organic bleaching agents can also be used. Typical organic bleaching agents are the diacyl peroxides such as, for example, dibenzoyl peroxide. Further typical organic bleaching agents are the peroxy acids, the alkylperoxy acids and arylperoxy acids being mentioned in particular as examples. Preferred representatives are (a) peroxybenzoic acid and its ring-substituted derivatives, such as alkylperoxybenzoic acids but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid, and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic) acid can be used.

Substances that release chlorine or bromine can also be used as bleaching agents. Appropriate among the materials releasing chlorine or bromine are, for example, heterocyclic N-bromamides and N-chloramides, for example trichloroisocyanuric acid, tribromoisocyanuric acid, dibromoisocyanuric acid, and/or dichloroisocyanuric acid (DICA) and/or their salts with cations such as potassium and sodium. Hydantoin compounds such as 1,3-dichloro-5,5-dimethylhydantoin are also suitable.

Washing or cleaning agents, in particular automatic dishwashing agents, that contain 1 to 35 wt %, by preference 2.5 to 30 wt %, particularly preferably 3.5 to 20 wt %, in particular 5 to 15 wt % bleaching agent, by preference sodium percarbonate, are preferred according to the present invention.

The active oxygen content of the washing or cleaning agent, in particular of the automatic dishwashing agent, is by preference between 0.4 and 10 wt %, particularly preferably 0.5 and 8 wt %, and in particular between 0.6 and 5 wt %, based in each case on the total weight of the agent. Particularly preferred agents have an active oxygen content above 0.3 wt %, preferably above 0.7 wt %, particularly preferably above 0.8 wt %, and in particular above 1.0 wt %.

Bleach Activators

Bleach activators as used in washing or cleaning agents, for example, order to achieve an improved bleaching effect when cleaning at temperatures of 60° C. and below. Compounds that, under perhydrolysis conditions, yield aliphatic peroxycarboxylic acids having preferably 1 to 10 carbon atoms, in particular 2 to 4 carbon atoms, and/or optionally substituted perbenzoic acid, can be used as bleach activators. Substances that carry O- and/or N-acyl groups having the aforesaid number of carbon atoms, and/or optionally substituted benzoyl groups, are suitable. Multiply acylated alkylenediamines, in particular tetraacetylethylenediamine (TAED), acylated triazine derivatives, in particular 1,5-diacetyl-2,2-dioxyhexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or isononanoyl oxybenzenesulfonate (n- and iso-NOBS), carboxylic acid anhydrides, in particular phthalic acid anhydride, acylated polyvalent alcohols, in particular triacetin, ethylene glycol diacetate, and 2,5-diacetoxy-2,5-dihydrofuran, are preferred.
Further bleach activators preferred for use in the context of the present application are compounds from the group of the cationic nitriles, in particular cationic nitriles of the formula 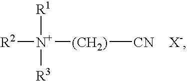
in which R¹ denotes —H, —CH₃, a C₂₋₂₄ alkyl or alkenyl radical, a substituted C₂₋₂₄ alkyl or alkenyl radical having at least one substituent from the group of —Cl, —Br, —OH, —NH₂, —CN, an alkyl or alkenylaryl radical having a C₁₋₂₄ alkyl group, or denotes a substituted alkyl or alkenylaryl radical having a C₁₋₂₄ alkyl group and at least one further substituent on the aromatic ring; R² and R³, mutually independently, are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6; and X is an anion.

Particularly preferred is a cationic nitrile of the formula 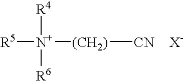
in which R⁴, R⁵ and R⁶ are selected, mutually independently, from —CH₃, —CH₂—CH₃, —CH₂—CH₂—CH₃, —CH(CH₃)—CH₃, where R⁴ can additionally also be —H; and X is an anion, such that preferably R⁵═R⁶═—CH₃ and in particular R⁴═R⁵═R⁶═—CH₃, and compounds of the formulas (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N^{(+)CH}₂—CN X⁻ are particularly preferred; of the group of these substances, the cationic nitrile of the formula (CH₃)₃N⁽⁺⁾CH₂—CN X⁻, in which X⁻ denotes an anion that is selected from the group of chloride, bromide, iodide, hydrogensulfate, methosulfate, p-toluenesulfonate (tosylate), or xylenesulfonate, is in turn particularly preferred.

Additionally usable as bleach activators are compounds that, under perhydrolysis conditions, yield aliphatic peroxycarboxylic acids having preferably 1 to 10 C atoms, in particular 2 to 4 C atoms, and/or optionally substituted perbenzoic acid. Substances that carry O- and/or N-acyl groups having the aforesaid number of C atoms, and/or optionally substituted benzoyl groups, are suitable. Multiply acylated alkylenediamines, in particular tetraacetylethylendiamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoylsuccinimide (NOSI), acylated phenolsulfonates, in particular n-nonanoyl or isononanoyl oxybenzenesulfonate (n- or iso-NOBS), carboxylic acid anhydrides, in particular phthalic acid anhydrides, acylated polyvalent alcohols, in particular triacetin, ethylene glycol diacetate, 2,5-diacetoxy-2,5-dihydrofuran, n-methylmorpholinium acetonitrile methyl sulfate (MMA), as well as acetylated sorbitol and mannitol and mixtures thereof (SORMAN), acylated sugar derivatives, in particular pentaacetylglucose (PAG), pentaacetylfructose, tetraacetylxylose and octaacetyllactose, as well as acetylated, optionally N-alkylated glucamine und gluco-nolactone, and/or N-acylated lactams, for example N-benzoylcaprolactam, are preferred. Hydrophilically substituted acyl acetates and acyl lactams are likewise used in preferred fashion. Combinations of conventional bleach activators can also be used.

If further bleach activators in addition to the nitrilquats are to be used, it is preferred to use bleach activators from the group of the multiply acylated alkylenediamines, in particular tetraacetylethylendiamine (TAED), N-acylimides, in particular N-nonanoyl-succinimide (NOSI), acylated phenolsulfonates, in particular n-nonanoyl or isononanoyl oxybenzenesulfonate (n- or iso-NOBS), n-methylmorpholinium acetonitrile methyl sulfate (MMA), by preference in quantities up to 10 wt %, in particular 0.1 wt % to 8 wt %, particularly 2 to 8 wt %, and particularly preferably 2 to 6 wt %, based in each case on the total weight of the bleach activator-containing agents.

In addition to or instead of the conventional bleach activators, so-called bleach catalysts can also be incorporated into the agents. These substances are bleach-intensifying transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, are also applicable as bleach catalysts.

Bleach-intensifying transition-metal complexes, in particular having the central atoms Mn, Fe, Co, Cu, Mo, V, Ti, and/or Ru, preferably selected from the group of the manganese and/or cobalt salts and/or complexes, particularly preferably the cobalt(ammine) complexes, the cobalt(acetate) complexes, the cobalt(carbonyl) complexes, the chlorides of cobalt or manganese, and manganese sulfate, are used in usual quantities, by preference in a quantity up to 5 wt %, in particular from 0.0025 wt % to 1 wt %, and particularly preferably from 0.01 wt % to 0.25 wt %, based in each case on the total weight of the bleach activator-containing agents. Even more bleach activator can, however, be used in specific cases.

Enzymes

Enzymes are usable in order to enhance the washing or cleaning performance of washing or cleaning agents. These include, in particular, proteases, amylases, lipases, hemicellulases, cellulases, or oxidoreductases, as well as preferably mixtures thereof. These enzymes are, in principle, of natural origin; improved variants based on the natural molecules are available for use in washing and cleaning agents and are correspondingly preferred for use. Washing or cleaning agents contain enzymes by preference in total quantities from 1×10⁻⁶ to 5 wt %, based on active protein. The protein concentration can be determined with known methods, for example the BCA method or the biuret method.

Among the proteases, those of the subtilisin type are preferred. Examples thereof are the subtilisins BPN′ and Carlsberg, protease PB92, subtilisins 147 and 309, the alkaline protease from Bacillus lentus, subtilisin DY, and the enzymes (to be classified, however, as subtilases and no longer as subtilisins in the strict sense) thermitase, proteinase K, and proteases TW3 and TW7. Subtilisin Carlsberg is obtainable in further developed form under the trade name Alcalase® from Novozymes A/S, Bagsvaerd, Denmark. Subtilisins 147 and 309 are marketed by Novozymes under the trade names Esperase® and Savinase®, respectively. The variants listed under the designation BLAP® are derived from the protease from Bacillus lentus DSM 5483.

Other usable proteases are, for example, the enzymes obtainable under the trade names Durazym®, Relase®, Everlase®, Nafizym, Natalase®, Kannase®, and Ovozymes® from Novozymes, under the trade names Purafect®, Purafect® OxP and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan.

Examples of amylases usable according to the present invention are the α-amylases from Bacillus licheniformis, from B. amyloliquefaciens, or from B. stearothermophilus, and their further developments improved for use in washing and cleaning agents. The enzyme from B. licheniformus is available from Novozymes under the name Termamyl®, and from Genencor under the name Purastar® ST. Further developed products of these α-amylases are available from Novozymes under the trade names Duramyl® and Termamyl® ultra, from Genencor under the name Purastar® OxAm, and from Daiwa Seiko Inc., Tokyo, Japan, as Keistase®. The α-amylase from B. amyloliquefaciens is marketed by Novozymes under the name BAN®, and derived variants of the α-amylase from B. stearothermophilus are marketed, again by Novozymes, under the names BSG® and Novamyl®.

Additionally to be highlighted for this purpose are the α-amylase from Bacillus sp. A 7-7 (DSM 12368) and the cyclodextrin-glucanotransferase (CGTase) from B. agaradherens (DSM 9948).

The further developments of the α-amylase from Aspergillus niger and A. oryzae, obtainable from Novozymes under the trade names Fungamyl®, are also suitable. A further commercial product is, for example, Amylase-LT®.

Additionally usable according to the present invention are lipases or cutinases, in particular because of their triglyceride-cleaving activities but also in order to generate peracids in situ from suitable precursors. These include, for example, the lipases obtainable originally from Humicola lanuginosa (Thermomyces lanuginosus) or further developed lipases, in particular those having the D96L amino-acid exchange. They are marketed, for example, by Novozymes under the trade names Lipolase®, Lipolase® Ultra, LipoPrime®, Lipozyme®, and Lipex®. The cutinases that were originally isolated from Fusarium solani pisi and Humicola insolens are moreover usable. Usable lipases are likewise obtainable from Amano under the designations Lipase CE®, Lipase P®, Lipase B®, or Lipase CES®, Lipase AKG®, Bacillis sp. Lipase®, Lipase AP®, Lipase M-AP®, and Lipase AML®. The lipases and cutinases from, for example, Genencor, whose starting enzymes were originally isolated from Pseudomonas mendocina and Fusarium solanii, are usable. To be mentioned as further important commercial products are the preparations Ml Lipase® and Lipomax® originally marketed by Gist-Brocades, and the enzymes marketed by Meito Sangyo KK, Japan, under the names Lipase MY-30®, Lipase OF®, and Lipase PL®, as well as the Lumafast® product of Genencor.

It is additionally possible to use enzymes that are grouped under the term “hemicellulases.” These include, for example, mannanases, xanthanlyases, pectinlyases (=pectinases), pectinesterases, pectatelyases, xyloglucanases (=xylanases), pullulanases, and β-glucanases. Suitable mannanases are obtainable, for example, under the names Gamanase® and Pektinex AR® from Novozymes, under the name Rohapec® BIL from AB Enzymes, and under the name Pyrolase® from Diversa Corp., San Diego, Calif., USA. The β-glucanase recovered from B. subtilis is available under the name Cereflo® from Novozymes.

To enhance the bleaching effect, oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases), can be used according to the present invention. Suitable commercial products that may be mentioned are Denilite® 1 and 2 of Novozymes. Advantageously, by preference organic, particularly preferably aromatic compounds that interact with the enzymes are additionally added in order to intensify the activity of the relevant oxidoreductases (enhancers) or, if there is a large difference in redox potentials between the oxidizing enzymes and the dirt particles, to ensure electron flow (mediators).

The enzymes derive, for example, either originally from microorganisms, for example the genera Bacillus, Streptomyces, Humicola, or Pseudomonas, and/or are produced by suitable microorganisms in accordance with biotechnological methods known per se, for example by transgenic expression hosts of Bacillus species or filamentous fungi.

Purification of the relevant enzymes is by preference accomplished by way of methods established per se, for example by precipitation, sedimentation, concentration, filtration of the liquid phases, microfiltration, ultrafiltration, the action of chemicals, deodorization, or suitable combinations of these steps.

The enzymes can be used in any form established according to the existing art. These include, for example, the solid preparations obtained by granulation, extrusion, or lyophilization or, especially in the case of liquid or gelled agents, solutions of the enzymes, advantageously as concentrated as possible, low in water, and/or with stabilizers added.

Alternatively, the enzymes can be encapsulated for both the solid and the liquid administration form, for example by spray-drying or extrusion of the enzyme solution together with a preferably natural polymer, or in the form of capsules, for example ones in which the enzymes are enclosed e.g. in a solidified gel, or in those of the core-shell type, in which an enzyme-containing core is covered with a protective layer impermeable to water, air, and/or chemicals. Further active substances, for example stabilizers, emulsifiers, pigments, bleaching agents, or dyes, can additionally be applied in superimposed layers. Such capsules are applied in accordance with methods known per se, for example by vibratory or rolling granulation or in fluidized-bed processes. Such granules are advantageously low in dust, e.g. as a result of the application of polymeric film-forming agents, and are stable in storage thanks to the coating.

It is additionally possible to formulate two or more enzymes together, so that a single granule exhibits several enzyme activities.

A protein and/or enzyme can be protected, especially during storage, from damage such as, for example, inactivation, denaturing, or decomposition, e.g. resulting from physical influences, oxidation, or proteolytic cleavage. An inhibition of proteolysis is particularly preferred in the context of microbial recovery of the proteins and/or enzymes, in particular when the agents also contain proteases. Washing or cleaning agents can contain stabilizers for this purpose; the provision of such agents represents a preferred embodiment of the present invention.

Reversible protease inhibitors are one group of stabilizers. Benzamidine hydrochloride, borax, boric acids, boronic acids, or their salts or esters are often used, among them principally derivatives having aromatic groups, e.g. ortho-substituted, meta-substituted, or para-substituted phenylboronic acids, or their respective salts or esters. Ovomucoid and leupeptin, among others, may be mentioned as peptide protease inhibitors; an additional option is the creation of fusion proteins from proteases and peptide inhibitors.

Further enzyme stabilizers are aminoalcohols such as mono-, di-, triethanol- and -propanolamine and mixtures thereof, aliphatic carboxylic acids up to C₁₂ such as succinic acid, other dicarboxylic acids, or salts of the aforesaid acids. End-capped fatty acid amide alkoxylates are also suitable. Certain organic acids used as builders are additionally capable of stabilizing a contained enzyme.

Lower aliphatic alcohols, but principally polyols, for example glycerol, ethylene glycol, propylene glycol, or sorbitol, are other frequently used enzyme stabilizers. Calcium salts are likewise used, for example calcium acetate or calcium formate, as well as magnesium salts.

Polyamide oligomers or polymeric compounds such as lignin, water-soluble vinyl copolymers or cellulose ethers, acrylic polymers, and/or polyamides stabilize the enzyme preparation, inter alia with respect to physical influences or pH fluctuations. Polyamine-N-oxide-containing polymers act as enzyme stabilizers. Other polymeric stabilizers are the linear C₈-C₁₈ polyoxyalkylenes. Alkyl polyglycosides can stabilize the enzymatic components, and even improve their performance. Crosslinked nitrogen-containing compounds likewise act as enzyme stabilizers.

Reducing agents and antioxidants increase the stability of the enzymes with respect to oxidative breakdown. One sulfur-containing reducing agent is, for example, sodium sulfite.

Combinations of stabilizers are preferably used, for example made up of polyols, boric acid and/or borax, the combination of boric acid or borate, reducing salts, and succinic acid or other dicarboxylic acids, or the combination of boric acid or borate with polyols or polyamino compounds and with reducing salts. The effect of peptide aldehyde stabilizers is enhanced by the combination with boric acid and/or boric acid derivatives and polyols, and further intensified by the additional use of divalent cations such as, for example, calcium ions.

One or more enzymes and/or enzyme preparations, by preference solid protease preparations and/or amylase preparations, are preferably used, in quantities from 0.1 to 5 wt %, by preference from 0.2 to 4.5, and in particular from 0.4 to 4 wt %, based in each case on the entire enzyme-containing agent.

Disintegration Adjuvants

In order to facilitate the breakdown of prefabricated shaped elements, it is possible to incorporate disintegration adjuvants, so-called tablet bursting agents, into these agents in order to shorten breakdown times. Tablet bursting agents or breakdown accelerators are understood, in accordance with Römpp (9th ed., Vol. 6, p. 4440) and Voigt “Lehrbuch der pharmazeutischen Technologie” [Textbook of pharmaceutical technology] (6th ed., 1987, pp. 182-184) as adjuvants that ensure the rapid breakdown of tablets in water or gastric juice, and the release of drugs in resorbable form.

These substances, which because of their action are also referred to as “bursting” agents, increase in volume upon the entry of water; on the one hand, their own volume is increased (swelling), and on the other hand the release of gases can also generate a pressure that allows the tablets to break down into smaller particles. Familiar disintegration adjuvants are, for example, carbonate/citric acid systems; other organic acids can also be used. Swelling disintegration adjuvants are, for example, synthetic polymers such as polyvinylpyrrolidone (PVP), or natural polymers or modified natural substances such as cellulose and starch and their derivates, alginates, or casein derivatives.

Disintegration adjuvants are preferably used in quantities from 0.5 to 10 wt %, by preference 3 to 7 wt %, and in particular 4 to 6 wt %, based in each case on the total weight of the disintegration adjuvant-containing agent.

Cellulose-based disintegration agents are used as preferred disintegration agents in the context of the present invention, so that preferred washing and cleaning agents contain such a cellulose-based disintegration agent in quantities from 0.5 to 10 wt %, by preference 3 to 7 wt %, and in particular 4 to 6 wt %. Pure cellulose has the formal gross composition (C₆H₁₀O₅)ₙ, and in formal terms constitutes a β-1,4-polyacetal of cellobiose, which in turn is made up of two molecules of glucose. Suitable celluloses comprise approx. 500 to 5000 glucose units, and consequently have average molar weights from 50,000 to 500,000. Also usable in the context of the present invention as cellulose-based disintegration agents are cellulose derivatives that are obtainable from cellulose via polymer-analogous reactions. Such chemically modified celluloses comprise, for example, products of esterification or etherification processes in which hydroxy hydrogen atoms were substituted. Celluloses in which the hydroxy groups were replaced with functional groups that are not bound via an oxygen atom can also, however, be used as cellulose derivatives. The group of the cellulose derivatives embraces, for example, alkali celluloses, carboxymethyl cellulose (CMC), cellulose esters and ethers, and aminocelluloses. The aforesaid cellulose derivatives are preferably used not as the only cellulose-based disintegration agent but in a mixture with cellulose. The cellulose-derivative content of these mixtures is by preference below 50 wt %, particularly preferably below 20 wt %, based on the cellulose-based disintegration agent. Pure cellulose that is free of cellulose derivatives is particularly preferred for use as a cellulose-based disintegration agent.

The cellulose used as a disintegration adjuvant is preferably not used in finely divided form, but instead is converted into a coarser form, for example granulated or compacted, before being mixed into the premixtures that are to be compressed. The particle sizes of such disintegration agents are usually above 200 μm, by preference at least 90 wt % between 300 and 1600 μm, and in particular at least 90 wt % between 400 and 1200 μm. The coarser cellulose-based disintegration adjuvants mentioned above and described in more detail in the referenced documents are preferable for use as disintegration adjuvants in the context of the present invention, and are obtainable commercially, for example, from the Rettenmaier company under the designation Arbocel® TF-30-HG.

Microcrystalline cellulose can be used as a further cellulose-based disintegration agent or as a constituent of that component. This microcrystalline cellulose is obtained by partial hydrolysis of celluloses under conditions such that only the amorphous regions (approx. 30% of the total cellulose mass) of the celluloses are attacked and dissolve completely, but the crystalline regions (approx. 70%) remain undamaged. A subsequent disaggregation of the microfine celluloses produced by hydrolysis yields the microcrystalline celluloses, which have primary particle sizes of approx. 5 μm and are compactable, for example, into granules having an average particle size of 200 μm.

Preferred disintegration adjuvants, by preference a cellulose-based disintegration adjuvant, by preference in granular, co-granulated, or compacted form, are contained in the disintegration agent-containing agents in quantities from 0.5 to 10 wt %, by preference from 3 to 7 wt %, and in particular from 4 to 6 wt %, based in each case on the total weight of the disintegration agent-containing agent.

In addition, gas-evolving effervescence systems can furthermore be used in preferred fashion according to the present invention as tablet disintegration adjuvants. The gas-evolving effervescence system can be made up of a single substance that releases a gas upon contact with water. To be mentioned among these compounds is, in particular, magnesium peroxide, which releases oxygen upon contact with water. Usually, however, the gas-releasing bubbling system is in turn made up of at least two constituents that react with one another to form gas. While a plurality of systems that release, for example, nitrogen, oxygen, or hydrogen are conceivable and implementable here, the bubbling system used in the washing and cleaning agents will be selected with regard to both economic and environmental considerations. Preferred effervescence systems comprise alkali-metal carbonate and/or hydrogencarbonate as well as an acidifying agent that is suitable for releasing carbon dioxide from the alkali-metal salts in aqueous solution.

Among the alkali-metal carbonates or hydrogencarbonates, the sodium and potassium salts are greatly preferred over the other salts for cost reasons. It is of course not necessary for the relevant pure alkali-metal carbonates or hydrogencarbonates to be used; mixtures of different carbonates and hydrogencarbonates can instead be preferred.

Preferably 2 to 20 wt %, by preference 3 to 15 wt %, and in particular 5 to 10 wt % of an alkali-metal carbonate or hydrogencarbonate, as well as 1 to 15, by preference 2 to 12 wt % and in particular 3 to 10 wt % of an acidifying agent, based in each case on the total weight of the agent, are used as an effervescence system.

Boric acid, as well as alkali-metal hydrogensulfates, alkali-metal dihydrogenphosphates, and other inorganic salts are usable, for example, as acidifying agents that release carbon dioxide from the alkali salts in aqueous solution. Organic acidifying agents are preferably used, however, citric acid being a particularly preferred acidifying agent. Also usable in particular, however, are the other solid mono-, oligo-, and polycarboxylic acids. Of this group, tartaric acid, succinic acid, malonic acid, adipic acid, maleic acid, fumaric acid, oxalic acid, and polyacrylic acid are in turn preferred. Organic sulfonic acids such as amidosulfonic acid are likewise usable. Sokalan® DCS (trademark of BASF), a mixture of succinic acid (max. 31 wt %), glutaric acid (max. 50 wt %) and adipic acid (max. 33 wt %), is commercially obtainable and likewise preferred for use as an acidifying agent in the context of the present invention.

Acidifying agents in the effervescence system from the group of the organic di-, tri-, and oligocarboxylic acids, or mixtures, are preferred.

Fragances

Individual odorant compounds, e.g. the synthetic products of the ester, ether, aldehyde, ketone, alcohol, and hydrocarbon types, can be used in the context of the present invention as perfume oils or fragrances. Odorant compounds of the ester type are, for example, benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. The ethers include, for example, benzylethyl ether; the aldehydes, for example, the linear alkanals having 8-18 C atoms, citral, citronellal, citronellyloxyacetaldehyde, cyclamenaldehyde, hydroxycitronellal, lilial and bourgeonal; the ketones, for example, the ionones, α-isomethylionone und methylcedryl ketone; the alcohols, anethol, citronellol, eugenol, geraniol, linalool, phenylethyl alcohol and terpineol; and the hydrocarbons include principally the terpenes such as limonene and pinene. Preferably, however, mixtures of different odorants that together produce an attractive fragrance note are used. Such perfume oils can also contain natural odorant mixtures, such as those accessible from plant sources, for example pine, citrus, jasmine, patchouli, rose, or ylang-ylang oil. Also suitable are muscatel, salvia oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

The general description of the usable perfumes (see above) represents in general the different substance classes of odorants. To be perceptible, an odorant must be volatile; in addition to the nature of the functional groups and the structure of the chemical compound, the molecular weight also plays an important part. Most odorants, for example, possess molar weights of up to approximately 200 dalton, while molar weights of 300 dalton and above represent something of an exception. Because of the differing volatility of odorants, the odor of a perfume or fragrance made up of multiple odorants changes during volatilization, the odor impressions being subdivided into a “top note,” “middle note” or “body,” and “end note” or “dry out.” Because the perception of an odor also depends a great deal on the odor intensity, the top note of a perfume or fragrance is not made up only of highly volatile compounds, while the end note comprises for the most part less-volatile, i.e. adherent odorants. In the compounding of perfumes, more-volatile odorants can, for example, be bound to specific fixatives, thereby preventing them from volatilizing too quickly. In the division below of odorants into “more-volatile” and “adherent” odorants, no statement is therefore made with regard to the odor impression, or as to whether the corresponding odorant is perceived as a top or middle note.

Adherent odorants that are usable in the context of the present invention are, for example, the essential oils such as angelica oil, anise oil, arnica flower oil, basil oil, bay oil, bergamot oil, champaca flower oil, silver fir oil, silver fir cone oil, elemi oil, eucalyptus oil, fennel oil, fir needle oil, galbanum oil, geranium oil, gingergrass oil, guaiac wood oil, balsam gurjun oil, helichrysum oil, ho oil, ginger oil, iris oil, cajeput oil, calamus oil, chamomile oil, camphor oil, kanaga oil, cardamom oil, cassia oil, pine needle oil, balsam copaiva oil, coriander oil, curled peppermint oil, caraway oil, cumin oil, lavender oil, lemon grass oil, lime oil, tangerine oil, lemon balm oil, ambrette seed oil, myrrh oil, clove oil, neroli oil, niaouli oil, olibanum oil, orange oil, oregano oil, palmarosa oil, patchouli oil, balsam peru oil, petitgrain oil, pepper oil, peppermint oil, pimento oil, pine oil, rose oil, rosemary oil, sandalwood oil, celery oil, spik oil, star anise oil, turpentine oil, thuja oil, thyme oil, verbena oil, vetiver oil, juniper berry oil, wormwood oil, wintergreen oil, ylang-ylang oil, ysop oil, cinnamon oil, cinnamon leaf oil, citronella oil, lemon oil, and cypress oil. The higher-boiling or solid odorants of natural or synthetic origin can, however, also be used in the context of the present invention as adherent odorants or odorant mixtures, i.e. fragrances. These compounds include the compounds recited below as well as mixtures thereof: ambrettolide, α-amylcinnamaldehyd, anethole, anisealdehyde, anise alcohol, anisole, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerate, bomeol, bornyl acetate, α-bromostyrene, n-decylaldehyde, n-dodecylaldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, cumarin, p-methoxyacetophenone, methyl-n-amylketone, methylanthranilic acid methyl ester, p-methylacetophenone, methylchavicol, p-methylquinoline, methyl-β-naphthylketone, methyl-n-nonylacetaldehyde, methyl-n-nonylketone, muscone, β-naphthol ethyl ether, β-naphthol methyl ether, nerol, nitrobenzene, n-nonylaldehyde, nonyl alcohol, n-octylaldehyde, p-oxyacetophenone, pentadecanolide, β-phenylethyl alcohol, phenylacetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, γ-undelactone, vanillin, veratrumaldehyde, cinnamaldehyde, cinnamyl alcohol, cinnamic acid, cinnamic acid ethyl ester, cinnamic acid benzyl ester. Included among the more-volatile odorants are, in particular, the lower-boiling odorants of natural or synthetic origin that can be used alone or in mixtures. Examples of more-volatile odorants are alkylsothiocyanates (alkylmustard oils), butanedione, limonene, linalool, linalyl acetate and propionate, menthol, menthone, methyl-n-heptenone, phellandrene, phenylacetaldehyde, terpinyl acetate, citral, citronellal.

The fragrances can be incorporated directly, but it may also be advantageous to apply the fragrances onto carriers that ensure a slower fragrance release for longer-lasting fragrance. Cyclodextrins, for example, have proven successful as carrier materials of this kind; the cyclodextrin-perfume complexes can additionally be coated with further adjuvants.

Dyes

Preferred dyes, the selection of which will present no difficulty whatsoever to one skilled in the art, possess excellent shelf stability and insensitivity to the other ingredients of the agents and to light, and no pronounced substantivity with respect to the substrates to be treated with the dye-containing agents, such as textiles, glass, ceramics, or plastic dishes, in order not to color them.

In selecting the coloring agent, care must be taken that, in the case of textile washing agents, the coloring agents do not exhibit too great an affinity for textile surfaces, and here in particular with respect to synthetic fibers, whereas in the case of cleaning agents an excessive affinity with respect to glass, ceramic, or plastic tableware must be avoided. At the same time, it must also be considered when selecting suitable coloring agents that coloring agents have differing levels of stability with respect to oxidation. It is generally the case that water-insoluble coloring agents are more stable with respect to oxidation than water-soluble coloring agents. The concentration of the coloring agent in the washing or cleaning agents varies as a function of solubility and thus also of oxidation sensitivity. For readily water-soluble coloring agents, e.g. the aforementioned Basacid® Green or (likewise aforesaid) Sandolan® Blue, coloring-agent concentrations in the range of a few 10⁻² to 10⁻³ wt % are typically selected. In the case of the pigment dyes, on the other hand, which are particularly preferred because of their brilliance but are less readily water-soluble, e.g. the aforesaid Pigmosol® dyes, the appropriate concentration of the coloring agent in the washing or cleaning agent is typically a few 10⁻³ to 10⁻⁴ wt %.

Coloring agents that can be oxidatively destroyed in the cleaning process, as well as mixtures thereof with suitable blue dyes, so-called bluing agents, are preferred. It has proven advantageous to use coloring agents that are soluble in water or at room temperature in liquid organic substances. Anionic coloring agents, e.g. anionic nitroso dyes, are suitable, for example. One possible coloring agent is, for example, naphthol green (Color Index (CI) Part 1: Acid Green 1; Part 2: 10020), which is available as a commercial product, for example, as Basacid® Green 970 of BASF, Ludwigshafen, as well as mixtures thereof with suitable blue dyes. Pigmosol® Blue 6900 (CI 74160), Pigmosol® Green 8730 (CI 74260), Basonyl® Red 545 FL (CI 45170), Sandolan® Rhodamine EB400 (CI 45100), Basacid® Yellow 094 (CI 47005), Sicovit® Patent Blue 85 E 131 (CI 42051), Acid Blue 183 (CAS 12217-22-0, CI Acidblue 183), Pigment Blue 15 (CI 74160), Supranol® Blue GLW (CAS 12219-32-8, CI Acidblue 221), Nylosan® Yellow N-7GL SGR (CAS 61814-57-1, CI Acidyellow 218) and/or Sandolan® Blue (CI Acid Blue 182, CAS 12219-26-0) are used as further coloring agents.

1-14. (canceled)

15. A liquid, cleaning-agent composition comprising:
(a) 35 to 95 wt % of one or more hydroxy mixed ethers according to the general formula:
R¹—O—[CH₂CH(R³)O]ₓ—[CH₂CH(OH)]—R²
wherein x represents a number greater than 1; R¹ represents a linear or branched, saturated or unsaturated, aliphatic or aromatic hydrocarbon radical having 1 to 30 carbon atoms; R² represents a linear or branched, saturated or unsaturated, aliphatic or aromatic hydrocarbon radical having 1 to 30 carbon atoms and, optionally, substituents selected from the group consisting of up to 5 hydroxy functionalities, up to 3 ether functionalities, and combinations thereof; and each R³ independently represents a substituent selected from the group consisting of hydrogen, methyl, ethyl, n-propyl, isopropyl, n-butyl, 2-butyl, and 2-methylbutyl; and
(b) 5 to 65 wt % of one or more glycerides selected from the group consisting of monoesters, diesters and triesters of glycerol with one or more C₁₀ monocarboxylic acids, and mixtures thereof.

16. The composition according to claim 15, wherein the one or more hydroxy mixed ethers is present in an amount of 35 to 80 wt %.

17. The composition according to claim 15, wherein the one or more glycerides is present in an amount of 10 to 60 wt %.

18. The composition according to claim 16, wherein the one or more glycerides is present in an amount of 10 to 60 wt %.

19. The composition according to claim 15, wherein the one or more glycerides comprises a monoester, diester or triester of glycerol with one or more C₁₋₄ monocarboxylic acids.

20. The composition according to claim 17, wherein the one or more glycerides comprises a monoester, diester or triester of glycerol with one or more C₁₋₄ monocarboxylic acids.

21. The composition according to claim 18, wherein the one or more glycerides comprises a monoester, diester or triester of glycerol with one or more C₁₋₄ monocarboxylic acids.

22. The composition according to claim 15, wherein the one or more glycerides comprises glycerol triacetate.

23. The composition according to claim 17, wherein the one or more glycerides comprises glycerol triacetate.

24. The composition according to claim 18, wherein the one or more glycerides comprises glycerol triacetate.

25. The composition according to claim 15, having a free water content of less than 10 wt %.

26. The composition according to claim 15, further comprising a corrosion inhibitor selected from the group consisting of silver corrosion inhibitors, glass corrosion inhibitors and combinations thereof.

27. The composition according to claim 26, wherein the corrosion inhibitor is present in an amount of 0.01 to 15 wt %.

28. The composition according to claim 15, further comprising a silver corrosion inhibitor selected from the group consisting of triazoles, benzotriazoles, bisbenzotriazoles, aminotriazoles, alkylaminotriazoles, transition-metal salts or complexes, and mixtures thereof.

29. The composition according to claim 15, further comprising a glass corrosion inhibitor selected from the group consisting of salts and complexes of magnesium, zinc and mixtures thereof.

30. The composition according to claim 15, further comprising a glass corrosion inhibitor selected from the group consisting of zinc silicate, zinc carbonate, zinc oxide, basic zinc carbonate, zinc hydroxide, zinc oxalate, zinc monophosphate, zinc pyrophosphate, zinc stearate, zinc oleate, zinc gluconate, zinc acetate, zinc lactate, zinc citrate, zinc ricinoleate, zinc abietate, zinc nitrate hexahydrate, zinc oxalate, and mixtures thereof.

31. The composition according to claim 15, further comprising a builder in an amount of less than 15 wt %.

32. The composition according to claim 31, wherein the builder comprises a water-soluble builder selected from the group consisting of citrates, phosphates and mixtures thereof.

33. A cleaning agent product comprising the composition according to claim 15, wherein the composition is encased in a film material selected from the group consisting of water-soluble films, water-dispersible films and combinations thereof.

34. A method comprising: (a) providing the composition according to claim 15; (b) introducing the composition into an automatic dishwashing apparatus; and (c) operating the automatic dishwashing apparatus.
